(19) United States
(12) Patent Application Publication
(10) Pub. No.: US 2025/0385881 A1
(43) Pub. Date: Dec. 18, 2025

(54) SECURE CONVERSATIONAL METHODS AND SYSTEMS FOR DATA ACCESS AND FACILITATION OF FIXED INCOME TRANSACTIONS

(71) Applicant: CapConnect+ Inc., Redwood City, CA (US)

(72) Inventors: Antony Maria Joseph Peter, Fremont, CA (US); Konstantinos Dafoulas, Concord, MA (US); Suresh Perera, San Carlos, CA (US); Brett Elliott Crozier, Coronado, CA (US)

(21) Appl. No.: 19/237,594

(22) Filed: Jun. 13, 2025

Related U.S. Application Data
(60) Provisional application No. 63/660,902, filed on Jun. 17, 2024.

(51) Int. Cl. H04L 51/02; G06F 40/30; G06Q 30/0202; G06Q 40/06; G06T 11/20; H04L 9/40

(52) U.S. Cl. CPC H04L 51/02; G06F 40/30; G06Q 30/0202; G06Q 40/06; G06T 11/206; H04L 63/04

(57) ABSTRACT

Various techniques can include receiving conversational queries from investors or issuers through a user interface module. The techniques can include processing the conversational queries using a machine learning module to derive context and intent. The techniques can include retrieving relevant user-specific data from a data repository through a data access module based on the processed conversational queries. The techniques can include generating conversational responses based on the retrieved relevant user-specific data. The techniques can include transmitting conversational responses to the investors or the issuers through the user interface module. The techniques can include invoking an investor-issuer matching module to match investors with relevant issuers based on the transaction parameters for commercial paper instruments. The techniques can include establishing secure direct communication channels between the matched investors and issuers to facilitate real-time negotiations and discussions related to a commercial paper transaction. Various systems which perform these techniques are also disclosed.

### CROSS REFERENCE TO RELATED APPLICATIONS

This application claims the benefit of U.S. Provisional patent application Ser. No. 63/660,902, filed on Jun. 17, 2024, the entire contents of which are hereby incorporated by reference in its entirety and for all purposes.

### BACKGROUND

Commercial paper is a form of unsecured, short-term debt instrument often used by companies to meet their short-term financing needs. Commercial paper can typically be issued by large corporations with high credit ratings and is a popular source of funding for meeting weighted capital needs, managing cash flows, or financing accounts receivable. The participants in a commercial paper or debt transaction can include issuers, investors, and financial brokers that act as a middleman between the issuers and investors. Issuers can include large corporations, financial institutions, and other creditworthy entities. Investors can include institutional investors, such as money market funds, insurance companies, pension funds, and high-net-worth individuals.

Commercial paper can have a short-term maturity, generally ranging from a few days to 270 days. Common maturities are 30, 60, or 90 days but may be much shorter. Commercial paper is not backed by collateral, solely relying on the issuer's creditworthiness. Typically, commercial paper is issued in large denominations, such as $100,000 or more. Commercial paper is usually issued at a discount to face value, with the difference between the issue price and the redemption value representing the interest carned by the investor. While most commercial paper is held until maturity, there is a secondary market for it, though it is less active than for other securities.

Commercial paper can be rated by credit rating agencies, with high ratings indicating lower risk. The rating can influence the interest rate and investor demand. Companies use commercial paper to fund short-term weighted capital needs. Commercial Paper can be cost-effective because it is typically cheaper than borrowing through traditional loans due to its short-term nature and high creditworthiness of issuers. The short-term capital can be used for procurement of stock, supplies, or even payroll. Commercial paper can offer flexibility in terms of maturity and amount, allowing issuers to tailor their financing to specific needs.

In the United States, commercial paper is exempt from Securities and Exchange Commission (SEC) registration if it has a maturity of 270 days or less and is used to finance current transactions. Despite exemptions, the commercial paper market is subject to regulatory oversight to ensure transparency and reduce systemic risk. Overall, commercial paper transactions play a crucial role in corporate finance, providing a flexible and cost-effective method for companies to meet their short-term funding requirements while offering investors a relatively safe investment option with short maturities.

Current techniques for commercial paper or debt transitions are normally dealer placed or through intermediaries like investment banks or dealers. Commercial paper transactions are often manual transactions with short timelines (e.g., some offerings lasting only a few minutes to hours) which can tie investors to financial terminals in anticipation of issuance. Further, the manual process is inefficient and can introduce errors into the formal documents for the transaction.

Currently dealers are publishing commercial paper transactions using financial terminals. Participants cannot project when they are likely to be in the market for a commercial paper transaction, they participants are either actively in the market or they are not.

Financial terminals can be used to determine current prices, but the transaction itself is conducted primarily through phone calls or electronic mail. Investors and issuers may feel tied to their financial terminals as to not miss opportunities and the fast-paced environment. Further, current techniques do not offer visibility on pricing to the issuers and investors, including transparency on demand for commercial paper, ability to learn from previous transactions through machine learning, and offer many opportunities for smaller investors to make these types of investments. Currently, issuers (e.g., organizations with great credit history) are going through dealers (e.g., large financial institutions (e.g., banks) to access investors for short-term capital requirements for running the business. This process costs issuers more due to inefficiencies and the cost by the dealers to access these investors. In addition, currently there is no visibility to the issuer on who the investors are and why they are purchasing the commercial paper.

It would be advantageous for an intelligent platform to bridge the gap digitally and provide a level of transparency between issuers, dealers, and investors. Further, the digital platform can increase accuracy and efficiency in commercial paper transactions.

These and other embodiments of the disclosure are described in detail below. For example, other embodiments are directed to systems, devices, and computer readable media associated with methods described herein.

A better understanding of the nature and advantages of embodiments of the present disclosure may be gained with reference to the following detailed description and the accompanying drawings.

### SUMMARY

Certain embodiments are directed at techniques (e.g., a system, a method, a memory or non-transitory computer readable medium storing code or instructions executable by one or more processors) for facilitating fixed income transactions.

Fixed income financial products are investment instruments that provide regular, predictable income, typically through interest or dividends. Fixed income products can include, but are not limited to bonds, certificates of deposit, securities, preferred stocks, fixed annuities, savings bonds, money market funds, commercial paper, mortgage-backed securities, and collateralized debt obligations (CDOs). These products are used by investors seeking stable and predictable returns, often with lower risk compared to equities. Each type of fixed income product has its own risk and return profile, making them suitable for different investment strategies and goals.

In one example, an issuer (e.g., a large retail corporate chain) may want to raise $1 billion in capital every two weeks to pay salaries. The issuer may then repay the loan after 5 days from other sources. Commercial paper is an attractive option for this type of transaction since the interest the company is receiving from other investments is greater than the interest paid for the short-term loan. This type of transaction can be used during high seasons of growth. For example, the borrowed funds can be used to purchase inventory for retail which is then sold during that season.

A direct commercial paper transaction can increase efficiency, transparency, and accuracy during the process. The disclosed techniques can even be used by dealers to increase efficiency and volume of transaction many multiple times.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, computer implemented methods may include receiving conversational queries from investors or issuers through a user interface module. The conversational queries can specify transaction parameters for commercial paper instruments. The computer implemented method may also include processing the conversational queries using a machine learning module to derive context and intent. The disclosed method may furthermore include retrieving relevant user-specific data from a data repository through a data access module based at least in part on the processed conversational queries. The disclosed method may include generating conversational responses based at least in part on the retrieved relevant user-specific data. The method may include transmitting conversational responses to the investors or the issuers through the user interface module. The method may also include invoking an investor-issuer matching module to match investors with relevant issuers based at least in part on the transaction parameters for commercial paper instruments. This method may furthermore include establishing secure direct communication channels between the matched investors and issuers to facilitate real-time negotiations and discussions related to a commercial paper transaction. Other embodiments of this aspect include corresponding computer systems, apparatus, and computer programs recorded on one or more computer storage devices, each configured to perform the actions of the methods.

Implementations may include one or more of the following features. The transaction parameters may include one or more of a desired commercial paper instrument size, a maturity, a pricing strategy, or other relevant terms. The computer implemented method may include generating custom reports using a reporting module based at least in part on the user-specific data and the conversational queries. The custom reports include visualizations, charts, or graphs. The computer implemented method may include generating predictive insights related to future deal outcomes, issuance performance, or debt raise success based on historical transaction data and user-specific data using a prediction module. The user interface module can be configured to facilitate multi-modal conversational interactions, including text, voice, or graphical interactions. The investor-issuer matching module can be configured to maintain confidentiality and privacy of investor and issuer information during the matching process and direct communication. The computer implemented method may include generating settlement documents for facilitating the execution and settlement of commercial paper transactions resulting from the direct connections between matched investors and issuers using an execution module integrated with existing financial systems or platforms.

The machine learning module can be configured to analyze conversational interactions and transaction data to improve the accuracy and relevance of investor-issuer matching over time. The data access module can be configured to enforce access control and data security policies to ensure secure retrieval and presentation of user-specific data.

The computer implemented methods may include receiving feedback from investors or issuers regarding the conversational responses; and incorporating the feedback into the machine learning module to improve future conversational interactions. Implementations of the described techniques may include hardware, a method or process, or a computer tangible medium.

In one general aspect, non-transitory computer-readable medium may include one or more instructions that, when executed by one or more processors of a device, cause the device to perform operations. The operations can include receiving conversational queries from investors or issuers through a user interface module. The conversational queries can specify transaction parameters for commercial paper instruments. The operations can include processing conversational queries using a machine learning module to derive context and intent.

The operations can include retrieving relevant user-specific data from a data repository through a data access module based at least in part on the processed conversational queries. The operations can include generating conversational responses based at least in part on the retrieved relevant user-specific data. The operations can include transmitting conversational responses to the investors or the issuers through the user interface module. The operations can include invoking an investor-issuer matching module to match investors with relevant issuers based at least in part on the transaction parameters for commercial paper instruments. The operations can include establishing secure direct communication channels between the matched investors and issuers to facilitate real-time negotiations and discussions related to a commercial paper transaction. Other embodiments of this aspect can include corresponding computer systems, apparatus, and computer programs recorded on one or more computer storage devices, each configured to perform the actions of the methods.

Implementations may include one or more of the following features. The transaction parameters can include one or more of a desired commercial paper instrument size, maturity, a pricing strategy, or other relevant terms. The operations can include generating custom reports using a reporting module based at least in part on the user-specific data and the conversational queries, where the custom reports include visualizations, charts, or graphs. The operations can include generating predictive insights related to future deal outcomes, issuance performance, or debt raise success based on the historical transaction data and user-specific data using a prediction module. The user interface module can be configured to facilitate multi-modal conversational interactions having at least one of text, voice, or graphical interactions. The investor-issuer matching module can be configured to maintain confidentiality and privacy of investor and issuer information during the matching process and direct communication. The operations can include generating settlement documents for facilitating the execution and settlement of commercial paper transactions resulting from the direct connections between matched investors and issuers using an execution module integrated with existing financial systems or platforms. The machine learning module can be configured to analyze conversational interactions and transaction data to improve the accuracy and relevance of investor-issuer matching over time. The data access module can be configured to enforce access control and data security policies to ensure secure retrieval and presentation of user-specific data. The operations can include receiving feedback from investors or issuers regarding the conversational responses; and incorporate the feedback into the machine learning module to improve future conversational interactions. Implementations of the described techniques may include hardware, a method or process, or a computer tangible medium.

In one general aspect, a system may include one or more processors configured to perform certain operations that can include receiving conversational queries from investors or issuers through a user interface module. The conversational queries can specify transaction parameters for commercial paper instruments. The operations can include processing the conversational queries using a machine learning module to derive context and intent. The operations can include retrieving relevant user-specific data from a data repository through a data access module based at least in part on the processed conversational queries. The operations can include generating conversational responses based at least in part on the retrieved relevant user-specific data. The operations can include transmitting conversational responses to the investors or the issuers through the user interface module. The operations can include invoking an investor-issuer matching module to match investors with relevant issuers based at least in part on the transaction parameters for commercial paper instruments. The operations can include establishing secure direct communication channels between the matched investors and issuers to facilitate real-time negotiations and discussions related to a commercial paper transaction. Other embodiments of this aspect include corresponding computer systems, apparatus, and computer programs recorded on one or more computer storage devices, each configured to perform the actions of the methods.

Implementations may include one or more of the following features. The transaction parameters can include one or more of a desired commercial paper instrument size, maturity, a pricing strategy, or other relevant terms. The operations can include generating custom reports using a reporting module based at least in part on the user-specific data and the conversational queries. The custom reports can include visualizations, charts, or graphs. The operations can include generating predictive insights related to future deal outcomes, issuance performance, or debt raise success based on the historical transaction data and user-specific data using a prediction module. The user interface module can be configured to facilitate multi-modal conversational interactions, including at least one of text, voice, or graphical interactions. System where the investor-issuer matching module is configured to maintain confidentiality and privacy of investor and issuer information during the matching process and direct communication. The operations can include generating settlement documents for facilitating the execution and settlement of commercial paper transactions resulting from the direct connections between matched investors and issuers using an execution module integrated with existing financial systems or platforms. The operations can include analyzing conversational interactions and transaction data to improve the accuracy and relevance of investor-issuer matching over time. The operations can include enforcing access control and data security policies to ensure secure retrieval and presentation of user-specific data. The operations can include receiving feedback from investors or issuers regarding the conversational responses; and incorporate the feedback into the machine learning module to improve future conversational interactions. Implementations of the described techniques may include hardware, a method or process, or a computer tangible medium.

### BRIEF DESCRIPTION OF THE DRAWINGS

FIG. 1 illustrates an exemplary flow diagram for techniques for facilitation of commercial paper transactions.

FIG. 2 illustrates an exemplary organizational diagram for facilitation of commercial paper transactions.

FIG. 3 illustrates an exemplary swim lane diagram for facilitation of commercial paper transactions.

FIG. 4 illustrates a first exemplary graphical user interface for facilitation of commercial paper transactions.

FIG. 5 illustrates a second exemplary graphical user interface for pending pricing for a system for facilitation of commercial paper transactions.

FIG. 6 illustrates a third exemplary graphical user interface for upcoming deals for a system for facilitation of commercial paper transactions.

FIG. 7 illustrates a fourth exemplary graphical user interface for upcoming deals for a system for facilitation of commercial paper transactions.

FIG. 8 illustrates a fifth exemplary graphical user interface for a market order in commercial paper transactions.

FIG. 9 illustrates a confirmation for a market order in commercial paper transactions.

FIG. 10 illustrates a sixth exemplary graphical user interface for a limit order in commercial paper transactions.

FIG. 11 illustrates a seventh exemplary graphical user interface for an order distribution in commercial paper transactions.

FIG. 12 illustrates an eighth exemplary graphical user interface for an order distribution in commercial paper transactions.

FIG. 13 illustrates a ninth exemplary graphical user interface for an order distribution in commercial paper transactions.

FIG. 14 illustrates a tenth exemplary graphical user interface for an order distribution in commercial paper transactions.

FIG. 15 illustrates a first exemplary report for a commercial paper transaction.

FIG. 16 illustrates a second exemplary report for a commercial paper transaction.

FIG. 17 illustrates an exemplary issuer summary.

FIG. 18 illustrates an exemplary block diagram for a machine learning model for a commercial paper transaction.

FIG. 19 illustrates an exemplary process for commercial paper transactions.

FIG. 20 illustrates a block diagram of an exemplary electronic device.

Like reference, symbols in the various drawings indicate like elements, in accordance with certain example implementations. In addition, multiple instances of an element may be indicated by following a first number for the element with a letter or a hyphen and a second number.

### DETAILED DESCRIPTION

Certain embodiments are directed to techniques (e.g., a system, a method, a memory or non-transitory computer readable medium storing code or instructions executable by one or more processors) for facilitating fixed income transactions.

Unlike a bond issuance, commercial paper is not regulated by the SEC and therefore is very similar to a private placement. The disclosed digital system provides for direct connection, direct demand, transparency, and efficiency for commercial paper transactions. The system can provide a Dutch/reverse auction system which insures get a true visibility of real-world demand. For example, if there are 100 investors willing to purchase commercial paper but at different rates, the issuer can see real-world demand and make decisions to scale the issuance based on the market conditions.

The system can provide value to all actors in a commercial paper transaction. The issuer may want to borrow funds at a lower interest rate. The investors want the best investment possible, often seeking higher interest rates. Dealers can take a small fee and seek efficiency in the transaction cost.

Investors and the stakeholders may seek additional information about the commercial paper (e.g., same A1P1 type paper and a highest rated issuer but at a lower percentage value). The system may provide opportunities to increase the yield of the investments if investor stakeholders have information required to increase the size and the scope of the investment.

Investors often have institutional mandates for their investments (e.g., 10% of profile rated A1P1). Investors therefore look for companies that are issuing commercial paper that meet their institutional requirements. In order to meet these requirements, the investors need to manually calculate weighted averages to determine the best investment based on maturity and interest rate. In addition, the disclosed system can provide visibility into investment portfolio and distribution of the investment assets. The system also provides the investor with the ability to directly query issuers (e.g., large retailer) in a reverse inquiry without going through a dealer therefore providing a better return on the investment. The system provides the ability for reverse inquiry even for smaller investors.

The system can use machine learning and artificial intelligence to leverage issuer data, investor data, demand data, and financial data e.g., Depository Trust and Clearing Corporation (DTCC) data which determines the strength of depositaries in the United States, Secured Overnight Financing Rate (SOFR) in order to understand requirements, optimize and predict when to go to commercial paper market.

The system can use machine learning to discover who may be in the market for commercial paper over the next several days. The system can provide notification from those who may be in the market without the investor having to check financial terminals at various points of time during the day. The system allows for both market and limit orders. Current commercial paper transactions are market orders in which an investor provides investment size and interest rate. Limit orders allow investors to specify an additional investment amount based on a selected investment rate (e.g., $100 million if the issuer will pay 5.3% rate). This allows issuers to see what market orders are and what is the demand for limit orders, thereby allowing issuers the ability to optimize the commercial paper transaction based on the market demand.

A price optimizer feature can aggregate all firm orders including both market and limit orders and calculate the demand in real-time. As user slides the optimizer can reprioritize investments in price and overtime (the better rate offered earlier in time would win the allocation). The price optimizer can incorporate other inputs (e.g., concentration limits (no more than 20% in any one investor), diversity and inclusion of investment firms). The price optimizer can also recommend investors based on existing relationships (e.g., awarding 20% to top investors based on historical information) therefore rewarding/incentivizing existing relationships.

In the disclosed system the issuers get to define their capital paper transactions and plan ahead for the future issuance of commercial paper. Issuers and investors can be onboarded directly onto the platform using standard processes (e.g., Know Your Customer (KYC) processes). The KYC process can include verification of investment eligibility for regulation and compliance. In various embodiments, onboarding can include receiving contact and other business information for either the issuer or investor and providing secure credentials to access the platform. The onboarding can also receive acknowledgment of various disclosures and agree to certain terms and conditions of service.

Investors can be notified when specific issuers will enter the market, and the investors are notified according to a timetable for notification of investors as been met. For example, this may be a selected time before issuance (e.g., eight hours, or two hours, or one hour).

The Pricing Optimizer is an intelligent pricing tool that utilizes transparent pricing data driven approaches with advanced machine learning techniques to analyze various factors to provide an issuer with a decision tool to solve for optimal price/deal size dynamics. The Pricing Optimizer can consider the following factors: Investor Appetite, Issuance Goals, Diversity, Equity, and Inclusion (DEI) Goals, and Concentration limits & Investor Relations. By aggregating investor order book data, the Pricing Optimizer can gauge investor interest in an issuance at notional and rate levels. The techniques allow for specification of a desired funding amount and any flexibility regarding pricing. The optimizer considers these parameters when generating pricing recommendations. The Pricing Optimizer tool can allow for considerations of DEI Goals depending on a firm's commitments for allocations that can be reserved for some investors. The Pricing Optimizers can account for Concentration limits & Investor Relations based on the issuer's setting on limiting allocations to a specific sector or an individual investor to be no more than a specified amount.

Some of the benefits of the Pricing Optimizer can include Competitive Pricing, Increased Efficiency, Data-Driven Decisions, Successful Issuances, and Visibility of Investor Names. The Pricing Optimizer can help identify the most competitive rate at a certain notional amount that attracts sufficient investor interest to meet funding goals. By leveraging market data and automating pricing analysis, the Pricing Optimizer can save valuable time and resources during the issuance process. The Pricing Optimizer can remove guesswork from the pricing equation. Instead, the issuer can make informed pricing decisions backed by robust data analysis and market insights. By optimizing the pricing strategy, there is an increased likelihood of attracting sufficient investor demand and achieving a successful issuance that meets funding objectives. Additionally, the Pricing Optimizer can allow visibility in investors.

The techniques for facilitation of commercial paper provide clear explanations of the factors considered by the Pricing Optimizer and the rational behind its recommendations allowing stakeholders to make well-informed decisions with confidence. The techniques can allow issuers to set competitive pricing that attracts strong investor demand while maximizing return on investment. The optimizer can assist issuers in assessing investor demand and market conditions, giving clear visibility to the cost of capital at each level of market demand. By offering competitive rates, the issuer can attract a broader pool of potential investors, leading to a more successful issuance. A well-priced issuance demonstrates an issuer's financial acumen and strengthens the issuer's reputation in the commercial paper market, potentially leading to more favorable terms in future issuances.

The machine learning system can analyze market data (e.g., DTCC data) and/or behavior data (e.g., company policies) to predict issuers and what true market demand for commercial paper investments is likely to be. A machine learning system can be developed to analyze market data, such as trade information from the Depository Trust & Clearing Corporation (DTCC), alongside behavioral data, including company policies and financial disclosures, to predict both which issuers are likely to offer commercial paper (CP) and what the actual market demand for these investments is likely to be.

To begin, the objective of such a system would be twofold: first, to anticipate which firms are likely to issue or re-enter the CP market, and second, to estimate the true demand for CP not just what is currently observable in the issuance data, but also the latent demand that might go unmet due to market frictions or strategic issuer behavior.

The system would draw from a range of data sources. Market data would include transaction-level details from DTCC such as issuance volumes, yields, maturities, and counterparties. Additional financial indicators like interest rates, credit spreads, and issuer-specific credit ratings would offer context about the broader funding environment. On the other hand, behavioral data would include patterns of past issuance, treasury policies disclosed in filings, and sentiment extracted from earnings calls or press releases. Natural language processing techniques could be used to extract structured insights from unstructured text, such as SEC filings and corporate communications.

After gathering and preprocessing the data, the system would engineer features that capture both temporal dynamics (like rolling averages and volatility in issuance volumes or spreads) and qualitative signals (such as the tone of policy statements or public communications). This feature set would feed into two main predictive models.

The first model would focus on issuer prediction. It would classify or rank companies based on their likelihood to issue commercial paper in the near future. This model could use techniques such as decision trees, gradient-boosted machines, or time-series models like LSTMs, depending on the complexity of the behavior and the availability of historical data.

The second model would estimate demand for CP. It would predict the volume of commercial paper investors are likely to purchase, taking into account market yields, institutional portfolio behavior, and observable bids or interest when available. This model could take the form of a regression model or a more complex economic equilibrium model that tries to balance issuer supply and investor demand under varying market conditions.

By integrating the outputs of both models, the system could produce actionable insights, such as forecasting when supply and demand might be misaligned, identifying potential pricing anomalies, or stress-testing the market in scenarios where major issuers reduce their activity.

The system's performance would be evaluated using classification metrics like precision and recall for issuer prediction, and error-based metrics such as mean absolute error for demand estimation. Over time, the system could be deployed as an interactive dashboard or integrated into existing decision-support tools used by traders, analysts, or treasury teams.

For example, if a company like Apple has historically issued CP only when short-term rates fall below a certain threshold, and its latest earnings call emphasizes liquidity optimization, the system might flag Apple as a likely issuer in the near future, even before any issuance is formally reported. This predictive foresight could give investors or counterparties a competitive advantage.

Overall, by combining structured financial data with nuanced behavioral analysis, this kind of machine learning system could offer a more holistic and forward-looking view of the commercial paper market than traditional models. The machine learning tool will allow an issuer to see how the issuer is complying with their own company policies with respect to commercial paper transactions by providing visibility on who the investors are. Second, the machine learning tool will allow analysis of market data within the context of the company policies. Third, the machine learning tool will allow for recommendations on where investments should be made now and in the future.

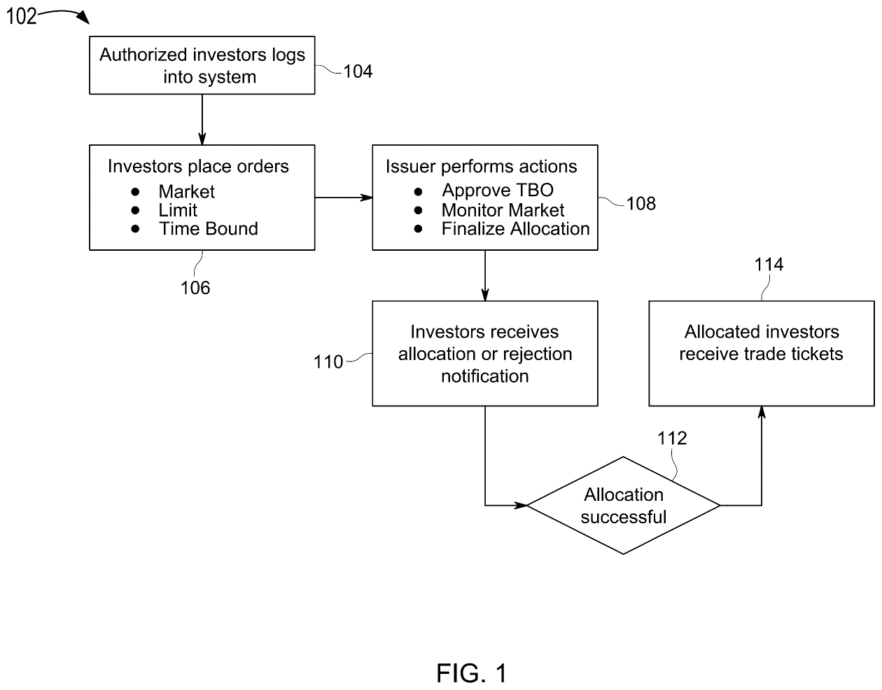

FIG. 1 illustrates an exemplary flow diagram 102 for techniques for facilitation of commercial paper transactions. In one embodiment, at block 104, authorized investors log into the system. System administrators can provide login credentials following a registration process. The registration process can allow for verification of the identity of the investor company and authorized users.

At block 106, investors can place orders for a commercial paper or debt instrument transaction. In various embodiments, the orders can be placed using a graphical user interface, a chatbot, a keyboard, or a pointing device. The investor can select market, limit, or time bound commercial paper or debt transactions.

At block 108, the issuer can approve transactions by others (TBO), monitor market conditional, and finalize allocation for a commercial paper/debt transaction. The issuer, usually a corporation, financial institution, or government entity, creates commercial paper to raise funds for short-term financial needs. These needs might include weighted capital, inventory financing, or covering seasonal fluctuations in cash flow.

The issuer prepares and files the necessary documentation to comply with regulatory requirements, including a prospectus or offering memorandum that outlines the terms of the commercial paper, such as interest rates, maturity dates, denominations, and payment details. The issuer sets the terms for the commercial paper, such as the interest rate, maturity period (typically 1 to 270 days), and denominations. The terms must be competitive and attractive to investors.

The issuer may work with credit rating agencies to obtain a credit rating for their commercial paper. A higher credit rating typically leads to lower borrowing costs and attracts more investors.

If the issuer uses a dealer or an underwriter, it will coordinate with them to sell the commercial paper to investors. The underwriter might help with structuring, pricing, and marketing the issuance to potential buyers.

The issuer, often through dealers or underwriters, arranges for the sale and distribution of commercial paper to investors, which can include money market funds, corporations, insurance companies, and other institutional investors.

The issuer uses the proceeds from the sale of commercial paper for their intended purposes, such as covering operational costs or funding specific projects. Proper cash management is crucial to ensure the issuer can meet its short-term obligations.

At the maturity of the commercial paper, the issuer must repay the principal to the investors. This might be done using cash on hand, revenue from operations, or by issuing new commercial paper in a process known as “rolling over” debt.

The issuer ensures compliance with regulatory and legal requirements, such as disclosure rules and financial reporting. Proper record-keeping and transparency are important to maintain investor confidence and comply with securities laws.

The issuer manages risks associated with issuing commercial paper, such as interest rate risk, liquidity risk, and market risk. This might involve hedging strategies or maintaining a cash reserve to meet obligations.

In summary, the issuer is responsible for the entire life cycle of a commercial paper transaction, from creating and issuing the paper to managing its use and repayment, all while ensuring compliance with relevant regulations and managing associated risks.

At block 110, investors can receive allocation or rejection notifications electronically. This electronic notification can be received on a mobile device (e.g., a smartphone, tablet, smart watch) thereby freeing the investor from being tied to a financial terminal for fear of missing an investment opportunity.

At block 112, the system can send an indication that the allocation was successful. The indication can also be sent via an electronic message that can be received on a mobile device (e.g., a smartphone, tablet, smart watch).

At block 114, the allocated investors can receive trade tickets. In various embodiments, the trade tickets can be sent via a voice trade confirmation system (e.g., Bloomberg VCON). Commercial paper trade tickets can be transmitted to investors through several methods, leveraging both traditional and modern digital communication channels. Some common methods can include electronic trading platforms, electronic mail, SWIFT secure messages, facsimile, web portals, and postal mail.

Electronic Trading Platforms can include dedicated platforms and automated systems. Commercial paper can be traded on electronic trading platforms specifically designed for money market instruments. Examples can include platforms like Bloomberg Terminal or Tradeweb. Automated Systems can generate and send trade confirmations or tickets directly to investors' accounts.

Trade tickets can be transmitted via electronic mail. For example, trade tickets can be generated electronically and sent as email attachments (typically PDFs) to investors. For enhanced security, encrypted email systems or secure email portals may be used to transmit sensitive financial information.

Society for Worldwide Interbank Financial Telecommunication (SWIFT) messages can also be used for transmitting trade tickets. Financial institutions use the SWIFT network to send secure messages regarding financial transactions, including commercial paper trade tickets.

Facsimile messages, though less common today, some transactions, especially in regions or institutions where electronic systems are not fully integrated, may still use facsimile to transmit trade tickets.

Web Portals can also be used to transmit trade tickets. Financial institutions or trading platforms may provide secure web portals where investors can log in to view and download trade tickets and other transaction documents.

Postal Mail can be used for physical delivery of trade tickets. For institutions or investors preferring physical documents, trade tickets can be printed and mailed through postal or courier services.

Blockchain Technology can be used to secure trade ticket information. For example, some modern systems use blockchain technology to create immutable records of transactions. Investors can access trade tickets through secure blockchain platforms.

Custom Integrations, application programming interface (API) end points, secure File Transfer Protocol (sFTP), Financial Information exchange (FIX) can also be used to transmit trade tickets. SFTP (Secure File Transfer Protocol) is a file transfer protocol that uses SSH encryption to securely transfer files between systems. The Financial Information exchange (FIX) is an information and data protocol used to disseminate price and trade information among investment banks and broker-dealers.

Considerations for Transmission can include security, compliance, speed, and accessibility. Ensuring the confidentiality and integrity of trade tickets can be paramount. Encryption and secure channels can be used to ensure security. Adhering to regulatory requirements for document transmission and record-keeping is critical in financial markets. Timely delivery of trade tickets is necessary to ensure prompt settlement and confirmation of transactions. Investors should have easy access to their trade tickets and the ability to retrieve them for future reference. Each of these methods has its own advantages and is chosen based on the specific requirements and preferences of the financial institution and the investors involved.

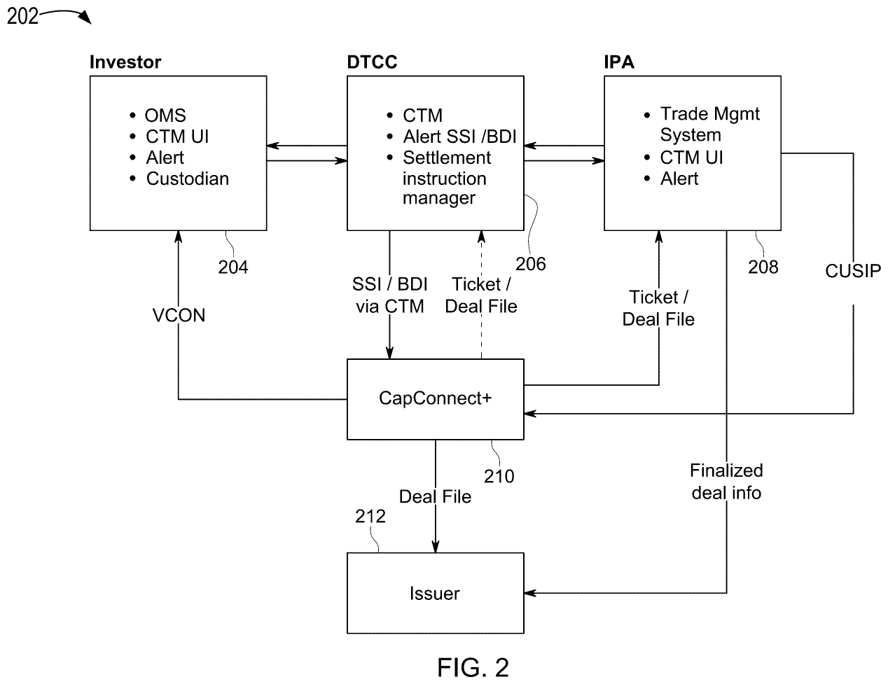

FIG. 2 illustrates exemplary organizational diagram 202 for facilitation of commercial paper transactions. FIG. 2 illustrates the interaction between various entities in a commercial paper transaction. Several entities can include an investor 204, the Deposit Trust Clearing Corporation 206, the issuing and paying agent (IPA) 208, the system 210 for facilitation of commercial paper, and the issuer 212.

For example, investor 204 can use an order management system (OMS) to submit orders for a commercial paper transaction. In various embodiments, investor 204 can enter the order via a central trade management system (e.g., Depository Trust and Clearing Corporation (DTCC)'s CTM). In various embodiments, the commercial orders can be submitted via machine-to-machine integration or simple file uploads. The central trade management system can be a platform for the central matching of cross-border and domestic transactions automates the trade confirmation process across multiple asset classes, such as equities, fixed income and repurchase agreements (repos). Investor 204 can set alerts for various alerts specifying parameters for requests for commercial paper or debt transactions.

DTCC 206 can access the central trade management system. DTCC 206 can issue Account Standing Settlement Instructions (SSI). SSI are predefined instructions for processing financial transactions between institutions, typically used in securities trading and settlement operations. SSI can streamline and standardize the transaction process by defining the specific details required for settlements, reducing errors and delays.

SSIs are designed to make the settlement process more efficient by eliminating the need to communicate specific settlement details for every transaction. They provide a standardized framework for the settlement of securities and other financial instruments. An SSI typically contains key information necessary for settlement, including settlement account details, such as the account number and the institution's name, the type of financial instrument being settled (e.g., stocks, bonds, or derivatives), settlement methods and instructions (e.g., via SWIFT, CREST, or other settlement systems), and any special instructions or conditions for the settlement process.

In securities trading, SSIs are used to instruct brokers, custodians, and other financial institutions on how to process settlements. SSIs can be employed in repetitive or frequent transactions, where it is more efficient to have a predefined set of instructions. Using SSIs reduces errors, speeds up the settlement process, and minimizes settlement risks. It also enhances operational efficiency by reducing the administrative overhead of processing each transaction manually.

DTCC 206 can send Beneficiary Details Information (BDI) to the commercial paper transaction system 210 (e.g., CapConnect+). The commercial paper transaction system 210 can send the ticket/deal file to the issuing and paying agent (IPA) 208 and the DTCC 206. This electronic sharing of information can improve the accuracy of the generation of documents for commercial paper.

An Issuing and Paying Agent (IPA) 208 is a financial institution, usually a bank, which is responsible for issuing and servicing short-term debt instruments, such as commercial paper, on behalf of a company or issuer. The IPA 208 plays an important role in facilitating the issuance, payment, and record-keeping of these securities, ensuring smooth transactions for both issuers and investors. IPA 208 issues commercial paper or other short-term debt instruments on behalf of a company or issuer. This involves coordinating with the issuer to determine the terms of the issuance, such as the interest rate, maturity date, and face value of the paper.

IPA 208 is responsible for ensuring that payments are made to holders of the debt when it matures. This involves handling the transfer of funds from the issuer to the investors, ensuring that payments are made on time and in accordance with the terms of the issuance.

The IPA 208 maintains records of all issued securities, tracking their status, ownership, and any changes over time. This can be important for transparency and compliance with regulations.

The IPA 208 ensures that the issuance and payment processes comply with relevant financial regulations and laws. This includes adhering to rules set by financial regulators and providing accurate reporting to stakeholders.

The IPA 208 may also handle communications with investors, providing information about the issuance and answering questions about payment schedules or other aspects of the debt instruments.

Overall, IPA 208 acts as an intermediary that simplifies the process of issuing and servicing short-term debt for companies, while providing a reliable point of contact for investors. This role is especially important in the commercial paper market, where issuers often rely on IPAs 208 to manage the complexities of issuance and payment.

The IPA 208 can interact with a trade management system through a user interface. The IPA 208 can set various alerts for facilitation of a commercial paper transaction. IPA 208 can generate and send Committee on Uniform Securities Identification Procedures (CUSIP) information to the commercial paper transaction system 210 (e.g., CapConnect+).

In various embodiments, the commercial paper transaction system 210 can be performed within a cloud computing environment. A cloud computing environment is a setup in which computing resources such as servers, storage, databases, networking, software, analytics, and intelligence are delivered over the internet (the cloud). This environment allows for flexible resources, economies of scale, and the ability to access information and services from anywhere with an internet connection.

Infrastructure as a Service (IaaS) models can provide virtualized computing resources over the internet. Examples can include but are not limited to Amazon Web Services (AWS), Microsoft Azure, and Google Cloud Platform (GCP). Platform as a Service (PaaS) service models can supply an environment for developers to build, deploy, and manage applications without worrying about the underlying infrastructure. Examples can include but are not limited to Google App Engine, Microsoft Azure App Services, and Heroku. Software as a Service (SaaS) models can deliver software applications over the internet on a subscription basis. Examples can include but are not limited to Google Workspace, Microsoft Office 365, and Salesforce.

Deployment models can include public cloud, private cloud, and hybrid cloud services. In a public cloud model, services can be delivered over the public network (e.g., the Internet) and shared across organizations. Examples can include but are not limited to AWS, Azure, and Google Cloud. Private Cloud Services can be maintained on a private network, offering greater control and security, typically for a single organization. Hybrid Cloud services can combine public and private clouds, allowing data and applications to be shared between them for greater flexibility and optimization of existing infrastructure.

Characteristics of cloud-based systems can include on-demand self-service, broad network access, resource pooling, rapid elasticity, and measured service. Users can provision computing resources automatically without human intervention from the service provider. Resources can be accessible over the network and can be accessed through standard mechanisms promoting use by heterogeneous thin or thick client platforms (e.g., mobile phones, tablets, laptops, and workstations). Provider's computing resources can be pooled to serve multiple consumers using a multi-tenant model, with different physical and virtual resources dynamically assigned and reassigned according to consumer demand. Capabilities can be elastically provisioned and released, in some cases automatically, to scale rapidly outward and inward commensurate with demand. Cloud systems can automatically control and optimize resource use by leveraging a metering capability at some level of abstraction appropriate to the type of service.

Some of the benefits of a cloud system can include cost efficiency, scalability, performance, global accessibility, backup and recovery, and collaboration. Cloud systems can reduce the capital expense of buying hardware and software and setting up and running on-site data centers. Cloud systems can easily scale resources up or down based on demand. Major cloud services can run on a worldwide network of secure data centers, which are regularly upgraded to the latest generation. Cloud services can provide global accessibility that enables access to services and data from any location with an internet connection. Cloud systems can provide backup and recovery that can simplify data backup and recovery by storing data in the cloud, offering redundancy and disaster recovery options. Cloud systems can facilitate collaboration by allowing multiple users to work on documents and projects in real-time from different locations. Cloud services can provide security features and compliance certifications to protect data and applications.

In summary, a cloud computing environment can provide a flexible, scalable, and cost-effective way to deliver and manage computing resources and services over the internet. It supports various service and deployment models, offering benefits like global accessibility, collaboration, and security while also presenting challenges related to security, compliance, and potential downtime.

CUSIP is a system used to uniquely identify financial instruments like stocks, bonds, and mutual funds in the United States and Canada. The CUSIP system provides a standardized way to assign a unique identifier to each security, making it easier to track, trade, and manage securities in financial markets. CUSIP numbers can be used to identify specific securities and facilitate efficient trading, clearing, and settlement processes. They can be an important component in ensuring that financial transactions are conducted smoothly and accurately. The IPA 208 can send the finalized deal information to the issuer 212. The commercial paper transaction system 210 can send the deal file to the issuer 212.

A CUSIP number can consist of nine characters. The first six characters represent the issuer (also known as the “issuer code”), the next two characters identify the specific security or issue (the “issue number”), and the last character is a check digit used for error checking. CUSIP numbers are assigned to a wide range of securities, including stocks, corporate bonds, government bonds, municipal bonds, mutual funds, and certain types of derivatives. Essentially, any financial instrument that requires unique identification in U.S. and Canadian markets is likely to have a CUSIP number. CUSIP numbers can be used by financial institutions, investors, and regulatory bodies to uniquely identify and track securities. CUSIP numbers can be essential for trading, clearing, and settlement processes, ensuring that transactions are properly recorded and reconciled. The CUSIP system is managed by the American Bankers Association (ABA) and operated by CUSIP Global Services (CGS), a division of Standard & Poor's. The system is designed to maintain a comprehensive and accurate database of CUSIP numbers, allowing for consistent and reliable identification of financial instruments. In summary, CUSIP is a standardized identification system that assigns unique codes to various financial instruments, facilitating efficient trading, tracking, and regulation in the financial markets of the U.S. and Canada.

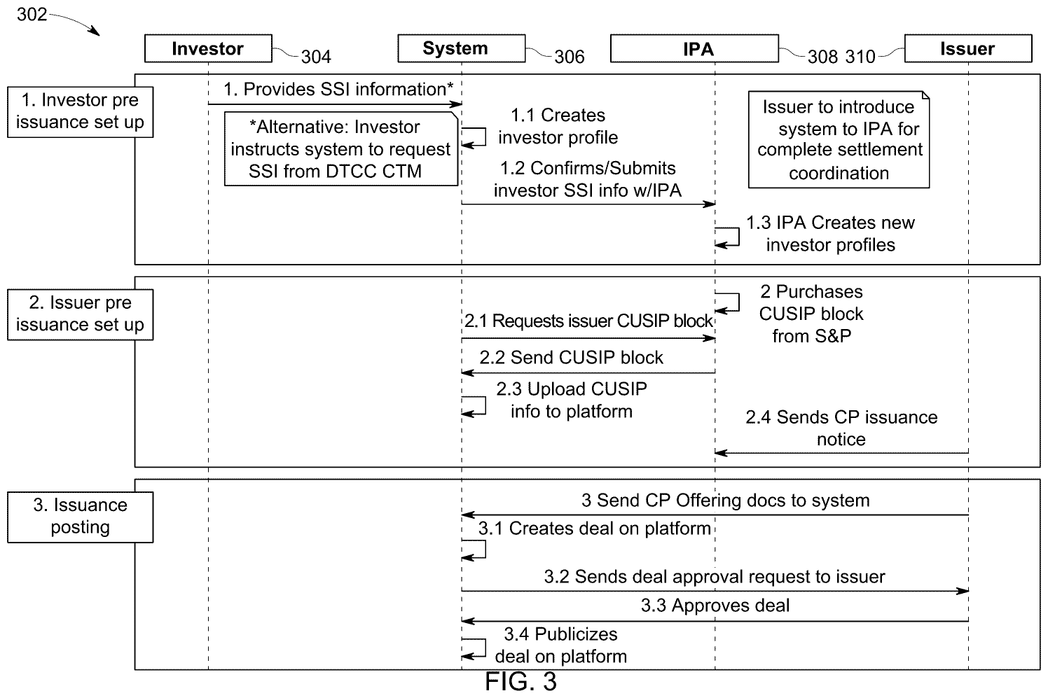

FIG. 3 illustrates an exemplary swim lane diagram 302 for facilitation of commercial paper transactions. A swim lane diagram is a type of flowchart that organizes activities, processes, or workflows into distinct “lanes,” visually separating different roles, departments, or functional areas. Swim lane diagrams can provide a clear way to represent complex processes by showing who is responsible for each step, where each task occurs, and how they interact across the workflow.

FIG. 3 illustrates the primary players in a commercial paper transaction as an investor 304, a system 306 (e.g., CapConnect+), the issuing and paying agent (IPA) 308, and the issuer 310.

In the first stage, investor 304 can conduct pre-issuance set-up. In various embodiments, investor 304 can provide SSI information. Alternatively, and/or additionally, the investor can instruct system 306 to request the SSI information from DTCC CTM.

System 306 can create an investor profile. The investor profile can be stored in memory. In various embodiments, system 306 can confirm or submit the investor SSI information with the IPA. In various embodiments, the investor profile may contain minimal personal information (e.g., may be limited to email address, first and last name, and role (e.g., trader versus investor or administrator).

In various embodiments, issuer 310 can introduce the system to the IPA 308 for complete settlement coordination. In various embodiments, the IPA 308 can create new investor profiles. The new investor profiles can be stored in memory.

In a second stage, issuer 310 can conduct pre-issuance set-up. The system 306 can request CUSIP block information. The CUSIP block information, as discussed above, can include data related to a specific set or range of CUSIP identifiers. CUSIP Block information can include a range of CUSIP identifiers that share common characteristics, such as those issued by the same company, financial institution, or a group of related securities (like a set of bonds issued by a single entity). It can also include a block of securities issued in a batch or over a particular timeframe. Information in a CUSIP Block can include details about the underlying securities within that range of identifiers. Information could encompass Security type (e.g., bond, stock, mutual fund), Issuer information (company or entity that issued the securities), Maturity dates for bonds or other fixed-income securities Terms and conditions of the securities (like interest rates for bonds), listing details (exchanges or markets where securities are traded), and other relevant financial data or corporate actions affecting the securities. CUSIP Block Information can be valuable for financial analysts, traders, investors, and compliance officers. It helps in managing portfolios, tracking securities, conducting research, and ensuring compliance with financial regulations. Institutions use this data for settlement, clearing, and reporting activities.

In various embodiments, the IPA 308 can send CUSIP block information to the system 306. System 306 can upload the CUSIP block information to the platform and store it in memory.

In various embodiments, the IPA 308 can purchase the CUSIP block information from a financial agency (e.g., Standard and Poor's). The IPA 308 can send the commercial paper issuance notice from the Issuer 310 to the IPA 308.

In a third stage, issuer 310 can send the commercial paper information documents to system 306. The system 306 can send deal approval request to the issuer 310. The issuer 310 can approve the deal. System 306 can publish the deal on the platform.

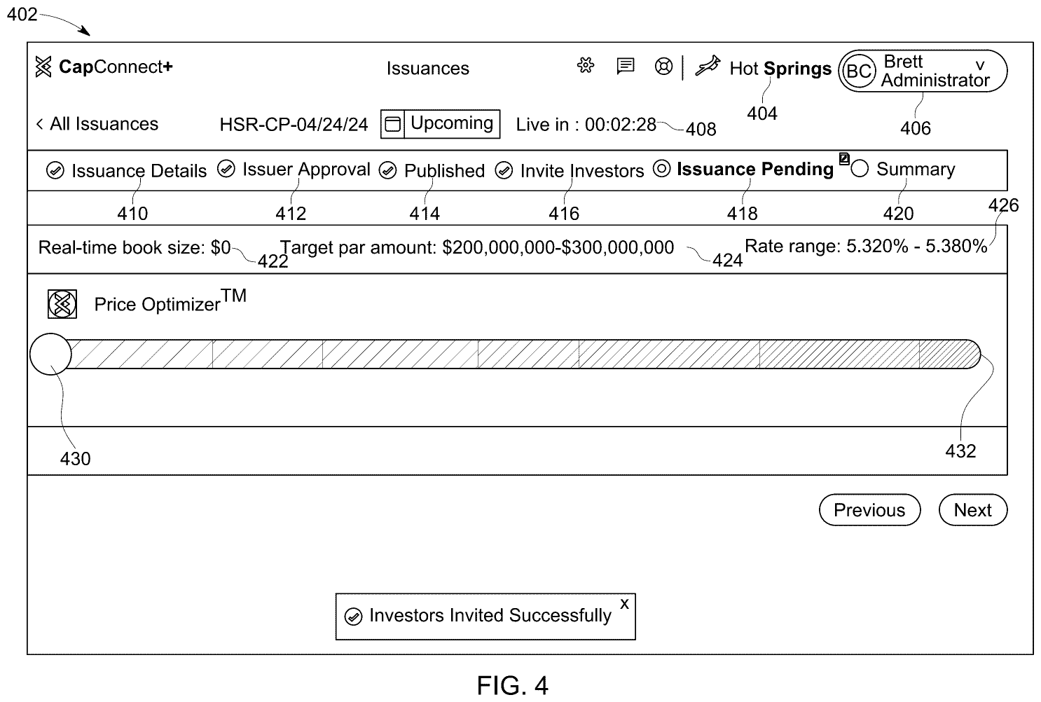

FIG. 4 illustrates a first exemplary graphical user interface 402 for facilitation of commercial paper transactions from the issuer perspective. The first exemplary graphical user interface 402 can be used to facilitate the issuer preparations for a commercial paper transaction.

In various embodiments, the first exemplary graphical user interface 402 can display the name of the Issuer 404 (e.g., Hot Springs) and the name and/or identity of the user 406. A countdown timer 408 until the live offering can also be displayed. The time for countdown timer 408 can be selected by the issuer (e.g., 3 minutes, 5 minutes, 1 hour, 5 hours, 5 days, etc.).

The first exemplary graphical user interface 402 can display a list of milestones (e.g., Issuance details 410, Issuer Approval 412, Published 414, Invite Investors 416, Issuance Pending 418, and Summary 420). The first exemplary graphical user interface 402 can include the real-time book size 422, the target par amount 424 (e.g., $200,000-$300,000), and the rate range 426 (5.320%-5.380%). The real-book size 422 in FIG. 4 is zero since the offering is not yet live.

The issuer can select the target par amount, the maturity date (e.g., preselected maturity number of days), and the rate range 426 for limit orders. As the auction goes live and market orders are placed the Price Optimizer slider can display the Weighted Average rate.

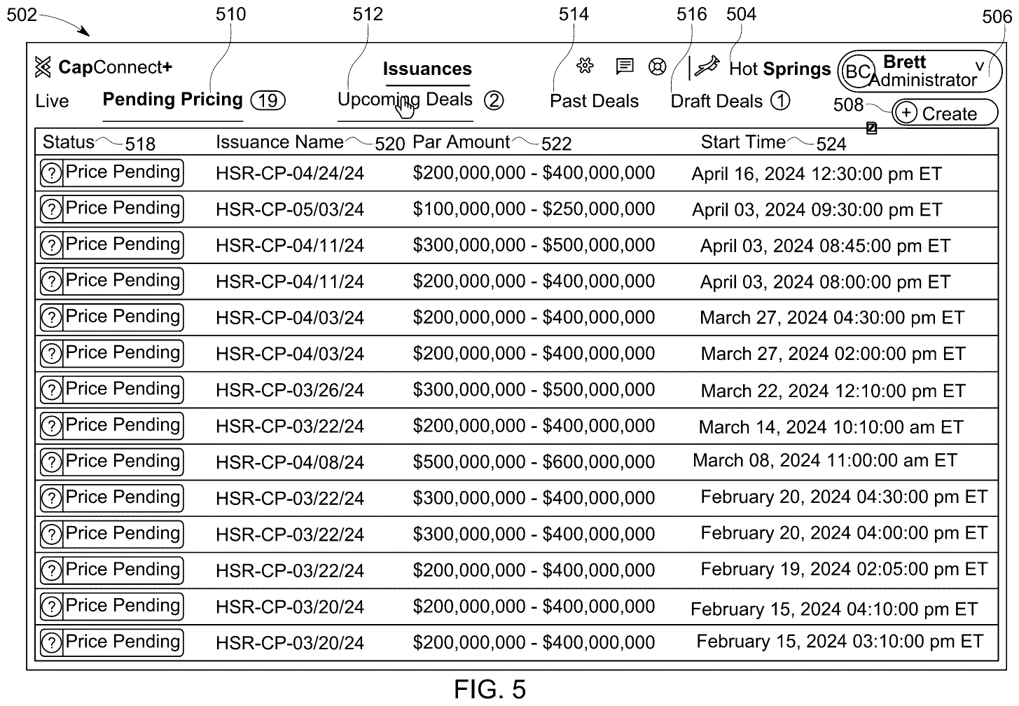

FIG. 5 illustrates a second exemplary graphical user interface 502 for pending pricing 510 for a system for facilitation of commercial paper transactions. In various embodiments, the second exemplary graphical user interface 502 can display the name of the Issuer 504 (e.g., Hot Springs) and the name and/or identity of the user 506. The second exemplary graphical user interface 502 allows for user 506 selection of pending pricing 510, upcoming deals 512, past deals 514, draft deals 516. User 506 can also select the create softkey 508 to enter new pending pricing 510 transactions. The second exemplary graphical user interface 502 allows a user to review various commercial paper pricing sessions that are scheduled thus providing an overview for the issuer in one display.

FIG. 5 illustrates a list of pending price transactions for commercial paper. The second exemplary graphical user interface 502 can display status for pending pricing 510 lists the status 518, the issuance name 520, the par amount 522 and the start time 524 for the live offering.

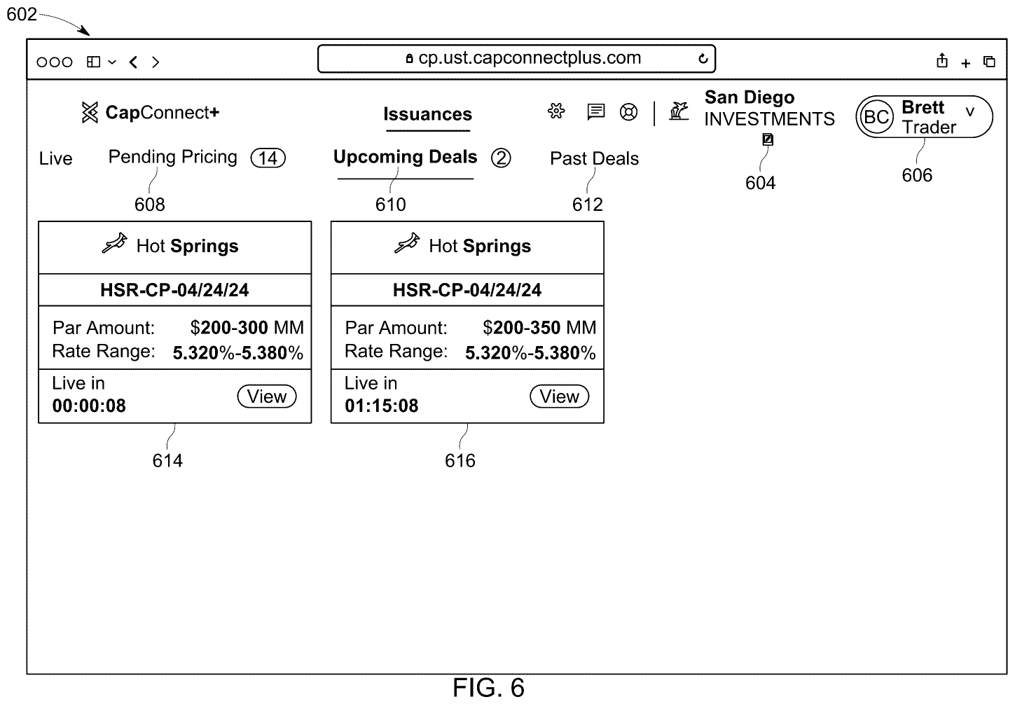

FIG. 6 illustrates a third exemplary graphical user interface 602 for upcoming deals for a system for facilitation of commercial paper transactions. The third exemplary graphical user interface 602 is from the perspective of an investor. In various embodiments, the third exemplary graphical user interface 602 can display the name of the Investor 604 (e.g., San Diego Investments) and the name and/or identity of the user 606. The third exemplary graphical user interface 602 can allow user 606 selection of pending pricing 608, upcoming deals 610 (e.g., as depicted in FIG. 6), and past deals 612.

FIG. 6 illustrates two upcoming deals with an Issuer (i.e., Hot Springs). FIG. 6 illustrates a first upcoming deal 614 with Hot Springs for a par amount of $200-$300 million and a rate range 5.320%-5.380% that starts in 8 seconds. FIG. 6 illustrates a second upcoming deal 616 with Hot Springs for a par amount of $200-$350 million with a rate range of 5.320%-5.380% that is live in one hour 15 minutes. While only two upcoming deals are illustrated as few as no upcoming deals and hundreds of upcoming deals can be displayed.

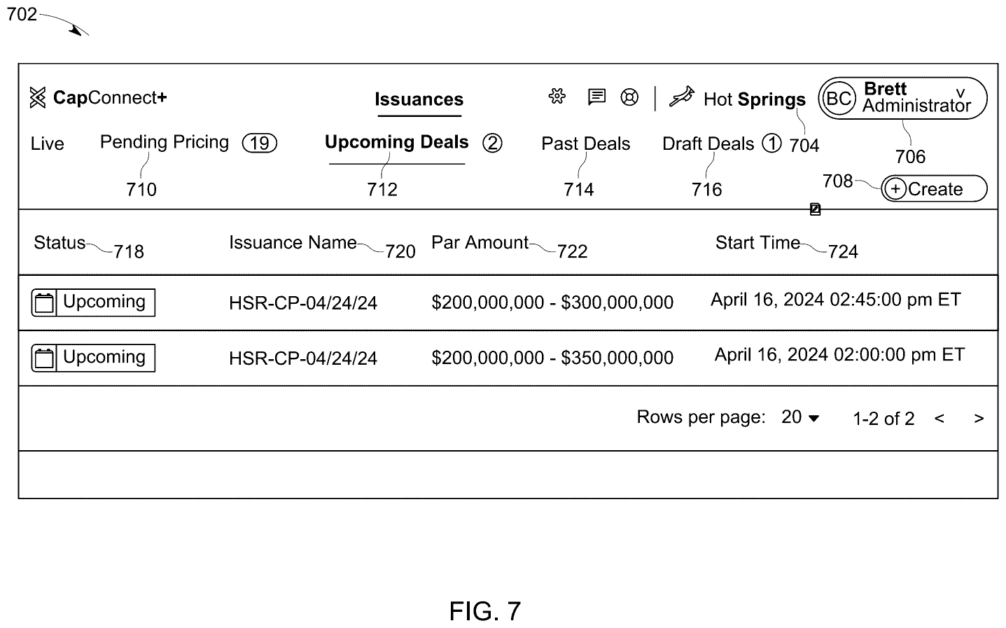

FIG. 7 illustrates a fourth exemplary graphical user interface 702 for upcoming deals for a system for facilitation of commercial paper transactions. The fourth exemplary graphical user interface 702 is from the perspective of an issuer. In various embodiments, the fourth exemplary graphical user interface 702 can display the name of the Issuer 704 (e.g., Hot Springs) and the name and/or identity of the user 706. The fourth exemplary graphical user interface 702 allows for user 706 selection of pending pricing 710, upcoming deals 712, past deals 714, draft deals 716 displays. The user 706 can also select the create softkey 708 to enter new upcoming deal 712 transactions.

FIG. 7 can display the states 718 (e.g., upcoming), the issuance name 720, the par amount 722, and start time 724 for upcoming deals 712. While only two upcoming deals are illustrated as few as no upcoming deals and hundreds of upcoming deals can be displayed.

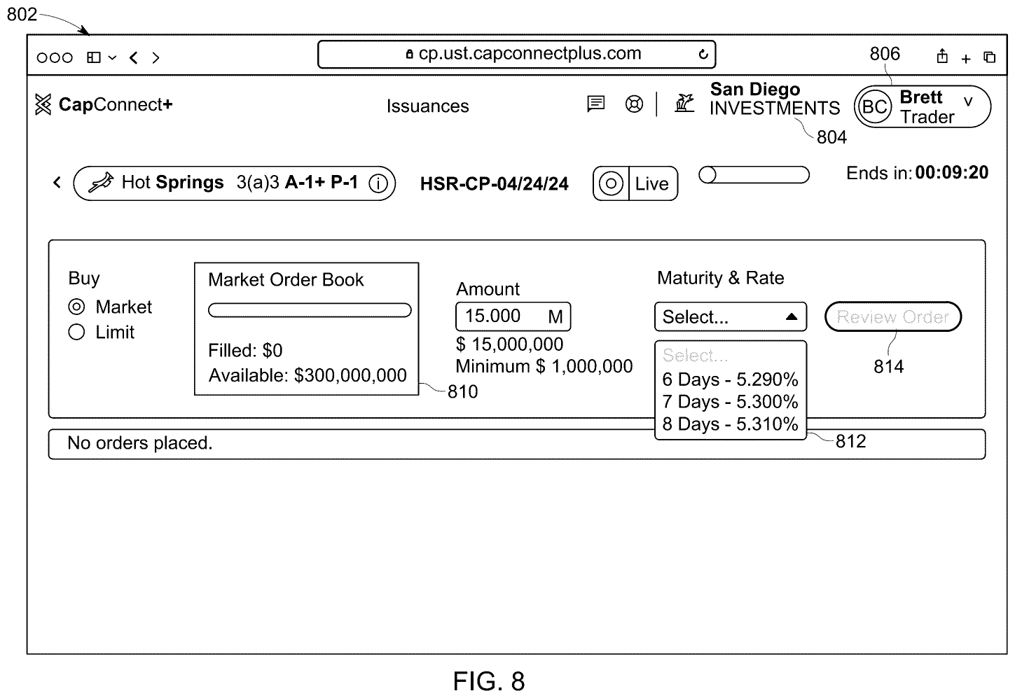

FIG. 8 illustrates a fifth exemplary graphical user interface 802 for a market order in commercial paper transactions. The fifth exemplary graphical user interface 802 is from the perspective of an investor 804 (e.g., San Diego investments) and lists a user 806. FIG. 8 illustrates an exemplary market order purchase. The fifth exemplary graphical user interface 802 illustrates the market order book 810 which displays how much of the market order has been already filled and how much is available to be filled. The fifth exemplary graphical user interface 802 allows the user 806 to select the amount of purchase, the maturity rate which a plurality of preselected rates 812. After making the selection, the fifth exemplary graphical user interface 802 allows for review of the order by the user 806 selecting the review order softkey 814.

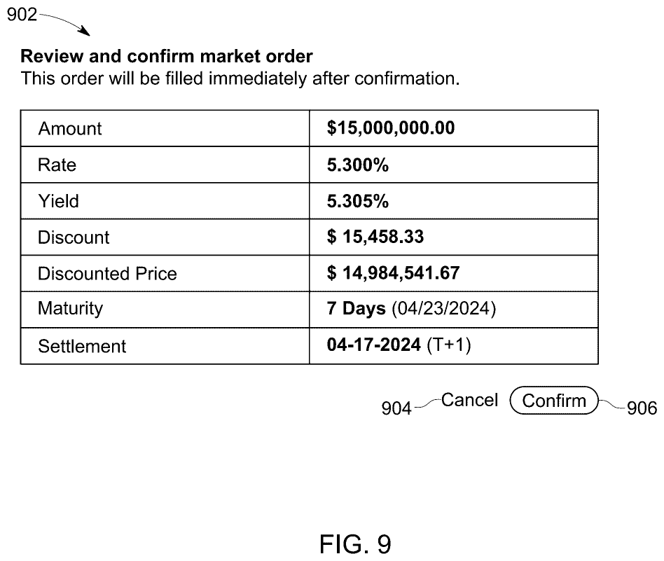

FIG. 9 illustrates a confirmation notice 902 for a market order in commercial paper transactions. In various embodiments, the confirmation notice 902 can include the amount (e.g., $15,000,000), the rate 5.300%, yield (e.g., 5.305%), the discount (e.g., $15,483.33), the discounted price (e.g., $14,984,541.67), the maturity date (e.g., 7 days), and the settlement date (e.g., Apr. 17, 2024 (T+1)). If the market order is not correct, then the user 802 can select the cancel softkey 904. If the market order is correct, user 802 can select the “confirm” softkey 906.

The sixth exemplary graphical user interface 1002 is from the perspective of an investor 1004 (e.g., San Diego investments) and lists a user 1006. FIG. 8 illustrates an exemplary limit order purchase. The sixth exemplary graphical user interface 1002 allows the user 1006 to select the amount of purchase, the maturity rate which a plurality of preselected rates 812. After making the selection, the fifth exemplary graphical user interface 802 allows for review of the order by the user 806 selecting the review order softkey 814.

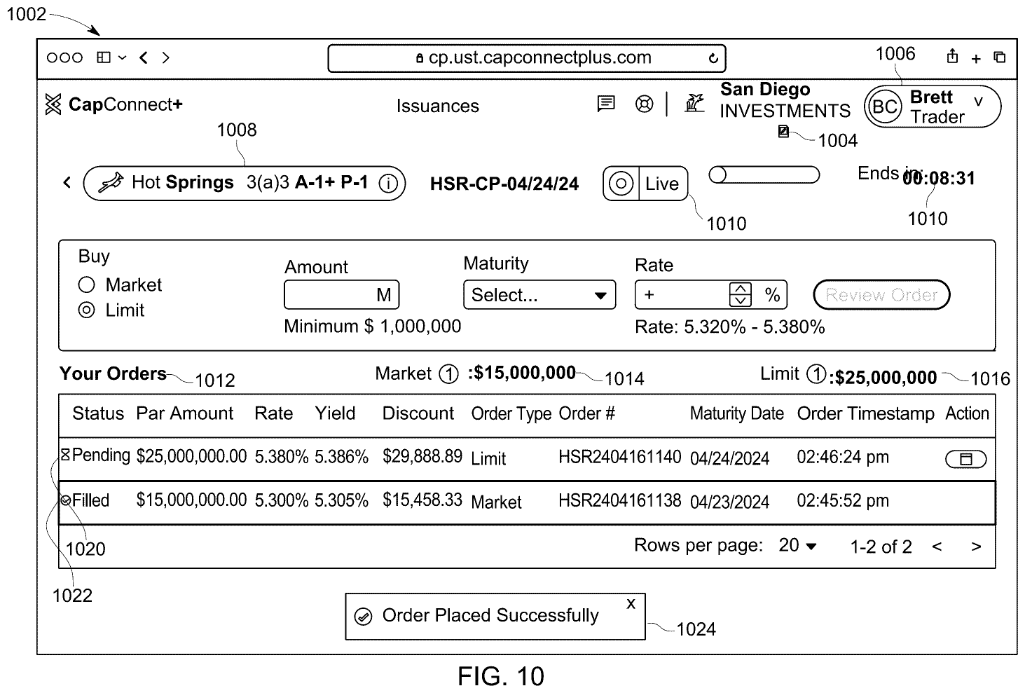

FIG. 10 illustrates a sixth exemplary graphical user interface 1002 for a limit order in commercial paper transactions. In the sixth exemplary graphical user interface 1002 can be used for an investor to make limit orders. The investor can enter the amount, the maturity, and the rate for the order. The sixth exemplary graphical user interface 1002 is from the perspective of an investor 1004 (e.g., San Diego investments) and lists a user 1006. The specific issuer 1008 (e.g., Hot Springs) can be displayed. FIG. 10 illustrates a status 1010 of the current offering and a countdown timer 1012 to indicate the end of the live offering.

The sixth exemplary graphical user interface 1002 can also display orders 1012 for the investor 1004, the market size 1014, and the limit 1016. The sixth exemplary graphical user interface 1002 can also display the status (e.g., Pending, Filled), Par Amount, Rate, Yield, Discount, Order Type, Order #, Maturity Date, Order Timestamp, and Action. In an example, a first order 1020 is pending and a second order 1022 is filled.

After the confirm softkey 906, see FIG. 9, the Order Placed Successfully message 1024 can be displayed on the sixth exemplary graphical user interface 1002.

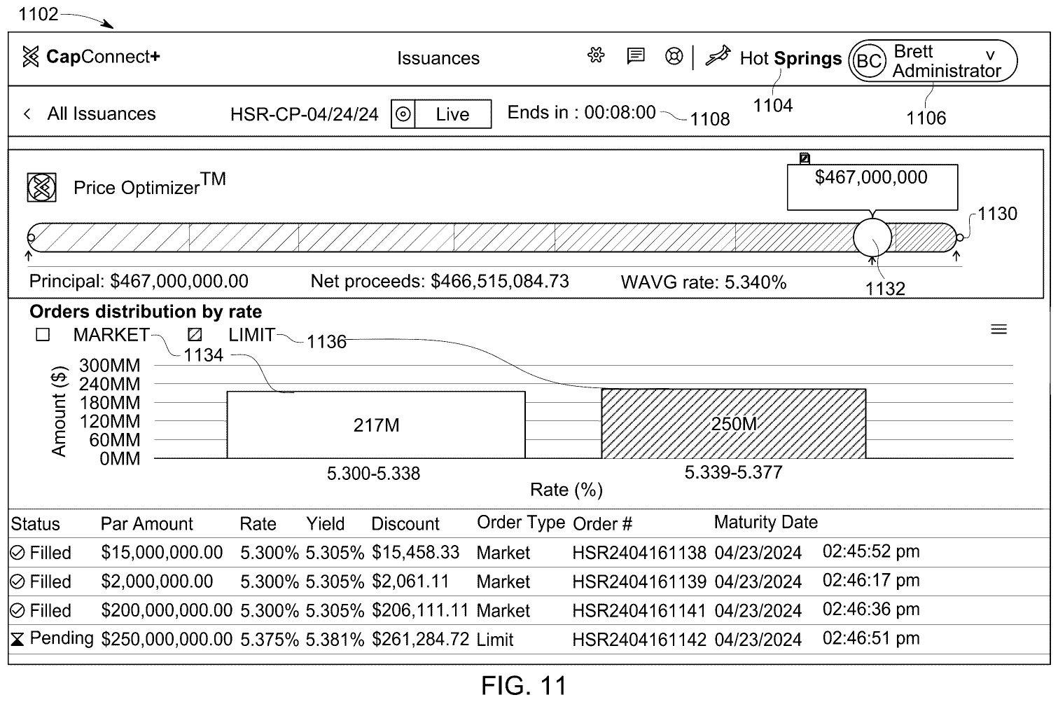

FIG. 11 illustrates a seventh exemplary graphical user interface 1102 for an order distribution in commercial paper transactions. The seventh exemplary graphical user interface 1102 is from the perspective of an issuer. In various embodiments, the seventh exemplary graphical user interface 1102 can display the name of the Issuer 1104 (e.g., Hot Springs) and the name and/or identity of the user 1106. FIG. 11 can illustrate a countdown timer 1108 to indicate the end of the live offering.

FIG. 11 illustrates an optimizer slider bar 1130. A user 1106 for the issuer can manipulate the optimizer bar that can change the allocation of market orders and limit orders for the issuer. The optimizer bar 1130 can display the principal amount, the net proceeds, and the weighted average rate between market and limit orders. Moving the optimizer slider 1132 to the left on the optimizer bar 1130 can reduce the percentage of limit orders for the commercial paper transaction. At the far-left end of the optimizer bar 1130 only market orders will be filled. Moving the optimizer slider 1132 to the right on the optimizer bar 1130 can increase the percentage of limit orders for the commercial paper transaction. At the far-right end of the optimizer bar all market and limit orders will be filled.

FIG. 11 illustrates a bar graph depicting the filled market orders 1134 and limit orders 1136. For example, in FIG. 11 there are $217,000 in filled market orders and $250,000 in pending limit orders. The seventh exemplary graphical user interface 1102 can display the status, the par amount, the rate, the yield, the discount, the order type, the order number, and maturity date for several orders that are either pending or filled.

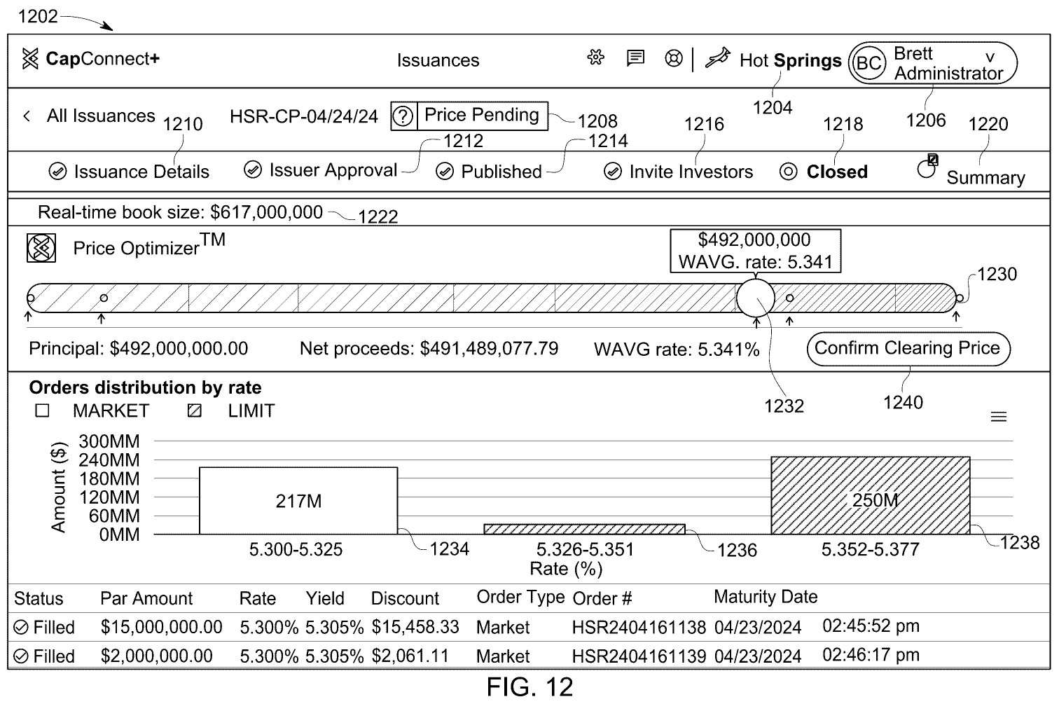

FIG. 12 illustrates an eighth exemplary graphical user interface 1202 for an order distribution in commercial paper transactions. The eighth exemplary graphical user interface 1202 is from the perspective of an issuer 1204. In various embodiments, the eighth exemplary graphical user interface 1202 can display the name of the issuer 1204 (e.g., Hot Springs) and the name and/or identity of the user 1206. The eighth exemplary graphical user interface 1202 can display a list of milestones (e.g., Issuance details 1210, Issuer Approval 1212, Published 1214, Invite Investors 1216, Status 1218 (e.g., Closed), and Summary 1220). In FIG. 12, the Status 1218 is closed and the eighth exemplary graphical user interface 1202 can display the real-time book size 1222.

FIG. 12 illustrates an optimizer slider bar 1230. A user 1206 for the issuer can manipulate the optimizer bar that can change the allocation of market orders and limit orders for the issuer 1204. The optimizer bar 1230 can display the principal amount, the net proceeds, and the weighted average rate between market and limit orders. Moving the optimizer slider 1232 to the left on the optimizer bar 1230 can reduce the percentage of limit orders for the commercial paper transaction. Moving the optimizer slider 1232 to the right on the optimizer bar 1230 can increase the percentage of limit orders for the commercial paper transaction. As Status 1218 is closed, the eighth exemplary graphical user interface 1202 can display a Confirm Clearing Price button 1240.

FIG. 12 illustrates a bar graph depicting the filled market orders 1234 and a first limit order 1236 and a second limit order 1238. For example, in FIG. 12 there are $217,000 in filled market orders and $250,000 in pending limit orders. The seventh exemplary graphical user interface 1202 can display the status, the par amount, the rate, the yield, the discount, the order type, the order number, and maturity date for several orders that are either pending or filled.

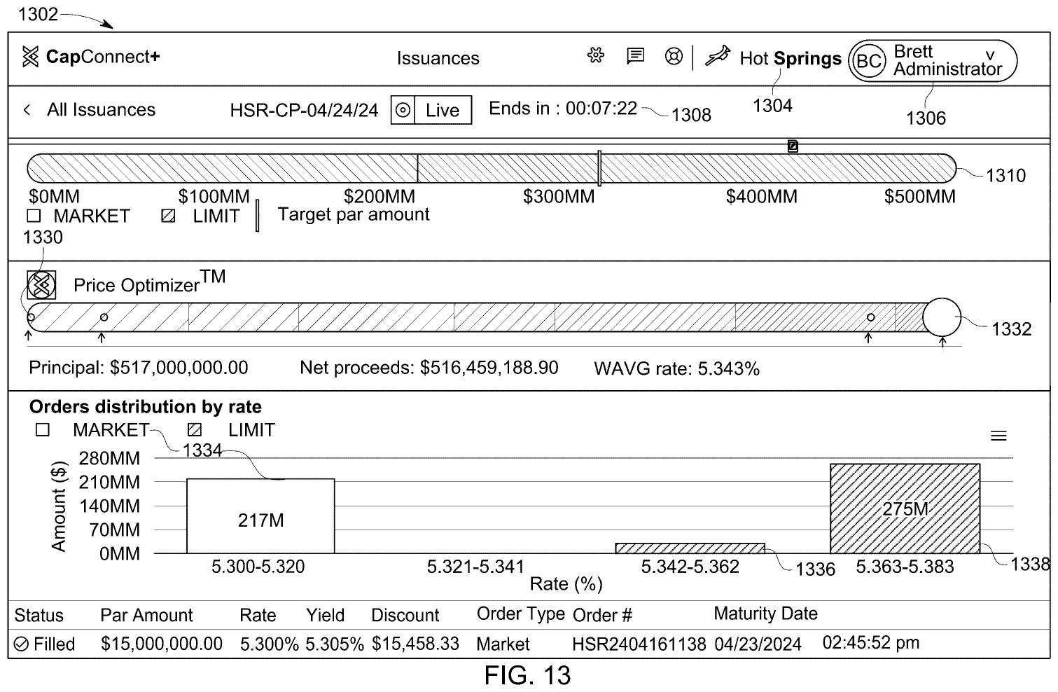

FIG. 13 illustrates a ninth exemplary graphical user interface 1302 for an order distribution in commercial paper transactions. The ninth exemplary graphical user interface 1302 is from the perspective of an issuer 1304. In various embodiments, the eighth exemplary graphical user interface 1302 can display the name of the issuer 1304 (e.g., Hot Springs) and the name and/or identity of the user 1306. The issuance illustrated in FIG. 13 is live and there is a countdown timer 1308 illustrating the time remaining until the issuance closes. FIG. 13 illustrates a distribution bar 1310 depicting the current distribution between market and limit orders.

FIG. 13 illustrates an optimizer slider bar 1330. A user 1306 for the issuer can manipulate the optimizer bar that can change the allocation of market orders and limit orders for the issuer 1304. The optimizer bar 1330 can display the principal amount, the net proceeds, and the weighted average rate between market and limit orders.

FIG. 13 illustrates a bar graph depicting the filled market orders 1334 and a first limit order 1236 at a first rate (e.g., 5.342-5.362%) and a second limit order 1238 at a second rate (e.g., 5.363-5.383%). For example, in FIG. 13 there is $217,000 in filled market orders and $300,000 in pending limit orders. The ninth exemplary graphical user interface 1302 can display the status, the par amount, the rate, the yield, the discount, the order type, the order number, and maturity date for several orders that are either pending or filled.

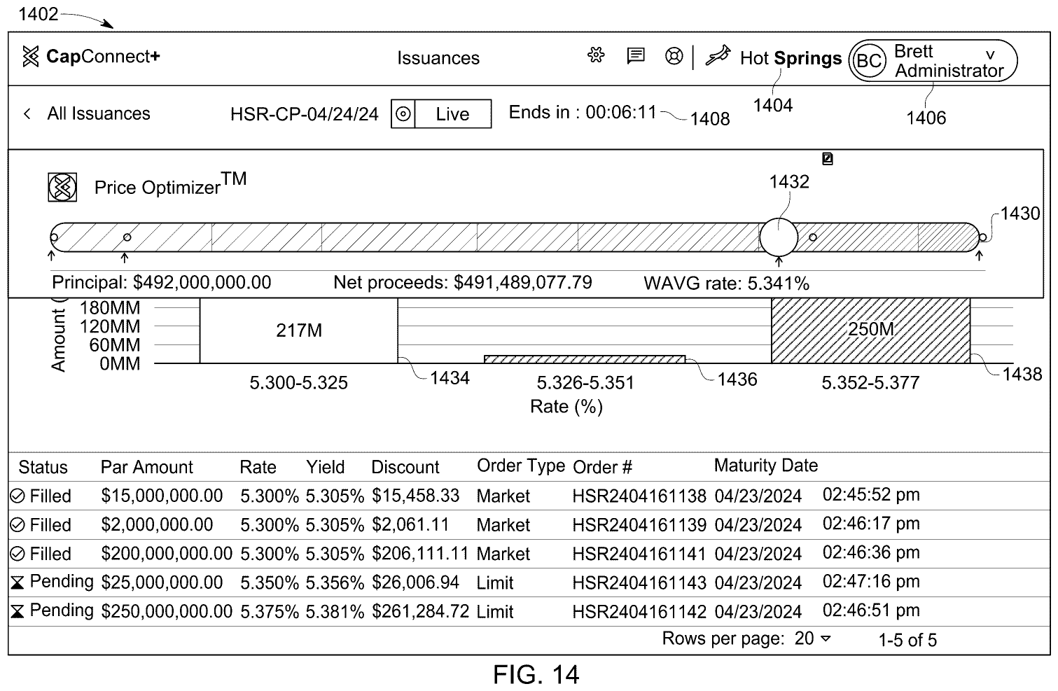

FIG. 14 illustrates a tenth exemplary graphical user interface 1402 for an order distribution in commercial paper transactions. The tenth exemplary graphical user interface 1402 is from the perspective of an issuer 1404. In various embodiments, the tenth exemplary graphical user interface 1402 can display the name of the issuer 1404 (e.g., Hot Springs) and the name and/or identity of the user 1406. The issuance illustrated in FIG. 14 is live and there is a countdown timer 1408 illustrating the time remaining until the issuance closes.

FIG. 14 illustrates an optimizer slider bar 1430. A user 1406 for the issuer can manipulate the optimizer slider bar 1430 that can change the allocation of market orders and limit orders for the issuer 1404. The optimizer slider bar 1430 can display the principal amount, the net proceeds, and the weighted average rate between market and limit orders.

FIG. 14 illustrates a bar graph depicting the filled market orders 1434 and a first limit order 1436 at a first rate (e.g., 5.326-5.351%) and a second limit order 1438 at a second rate (e.g., 5.352-5.377%). For example, in FIG. 14 there are $217,000 in filled market orders and $275,000 in pending limit orders. The tenth exemplary graphical user interface 1402 can display the status, the par amount, the rate, the yield, the discount, the order type, the order number, and maturity date for several orders that are either pending or filled.

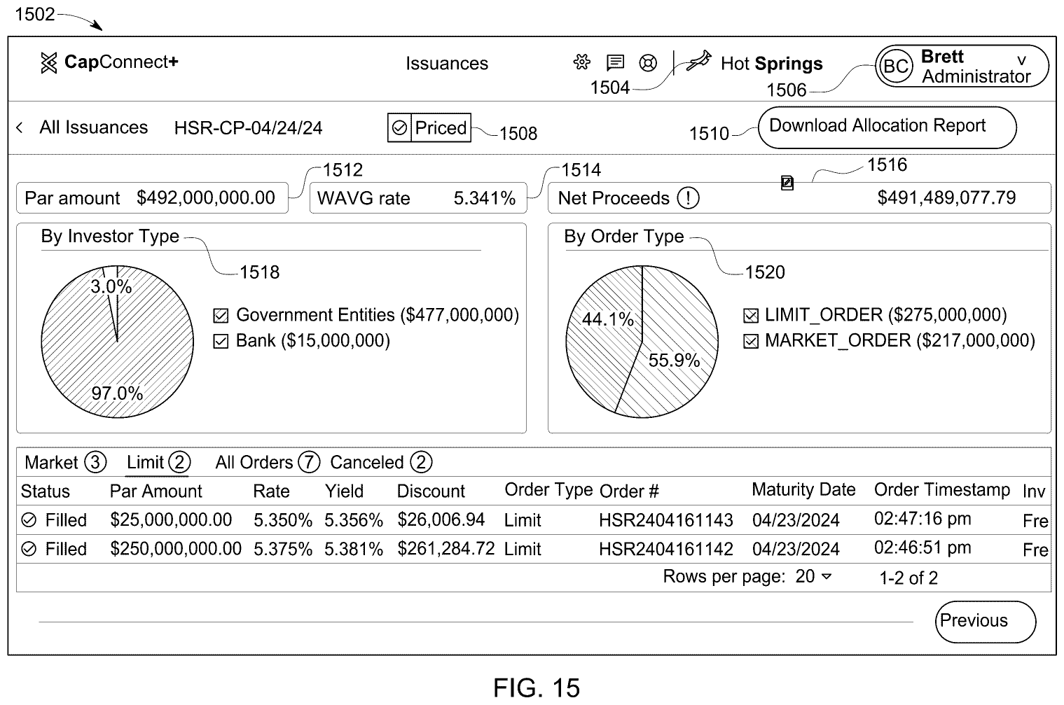

FIG. 15 illustrates a first exemplary allocation report 1502 for a commercial paper transaction. The first exemplary allocation report 1502 is from the perspective of an issuer 1504. In various embodiments, the first exemplary allocation report 1502 can display the name of the issuer 1504 (e.g., Hot Springs) and the name and/or identity of the user 506. The issuance illustrated in FIG. 14 is closed and the status 1508 indicates that the transaction has been priced. The first exemplary allocation report 1502 can display a download allocation report softkey 1510. The first exemplary allocation report 1502 can display the par amount 1512, the weighted average rate 1514, and the net proceeds 1516. The first exemplary allocation report 1502 can display a plurality of pie graphs. For example, a first pie graph 1518 can display a distribution by investor type (e.g., Government entities, bank, etc.) and a second pie graph 1520 can display a distribution by order type (e.g., limit orders and market orders). The first exemplary allocation report 1502 can display the status, the par amount, the rate, the yield, the discount, the order type, the order number, and maturity date for several orders that are either pending or filled.

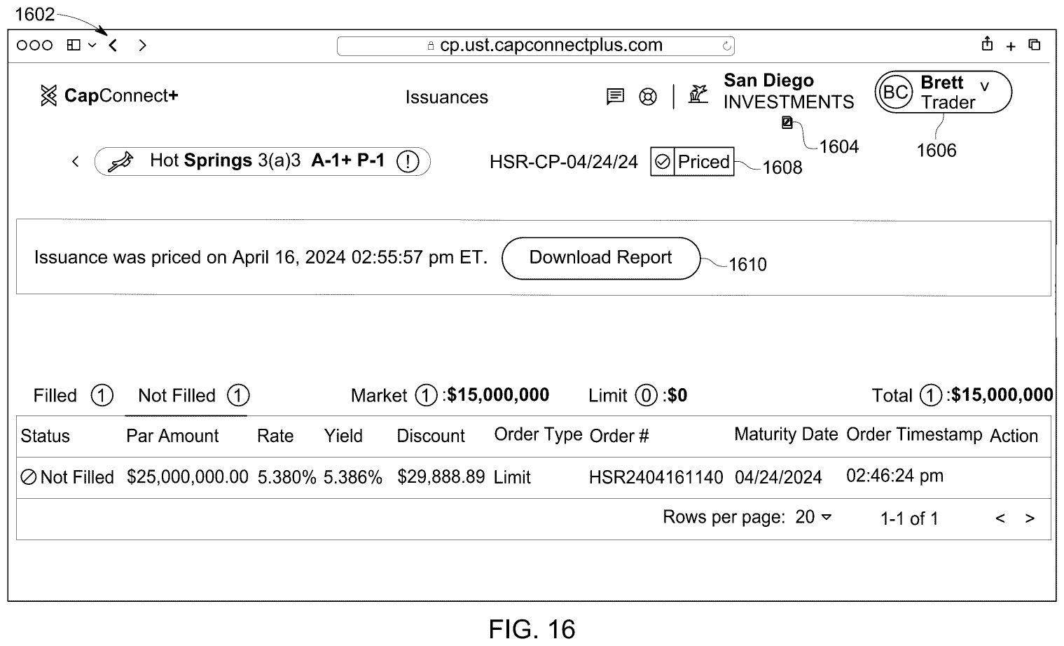

FIG. 16 illustrates a second exemplary report 1602 for a commercial paper transaction. The second exemplary report 1602 is from the perspective of an investor 1604. In various embodiments, the second exemplary report 1602 can display the name of the investor 1604 (e.g., San Diego Investments) and the name and/or identity of the user 1606. The issuance illustrated in FIG. 16 is closed and the status 1608 indicates that the transaction has been priced. The second exemplary allocation report 1602 can display a download report softkey 1610.

The second exemplary allocation report 1602 can display the status, the par amount, the rate, the yield, the discount, the order type, the order number, and maturity date for several orders that are either pending or filled.

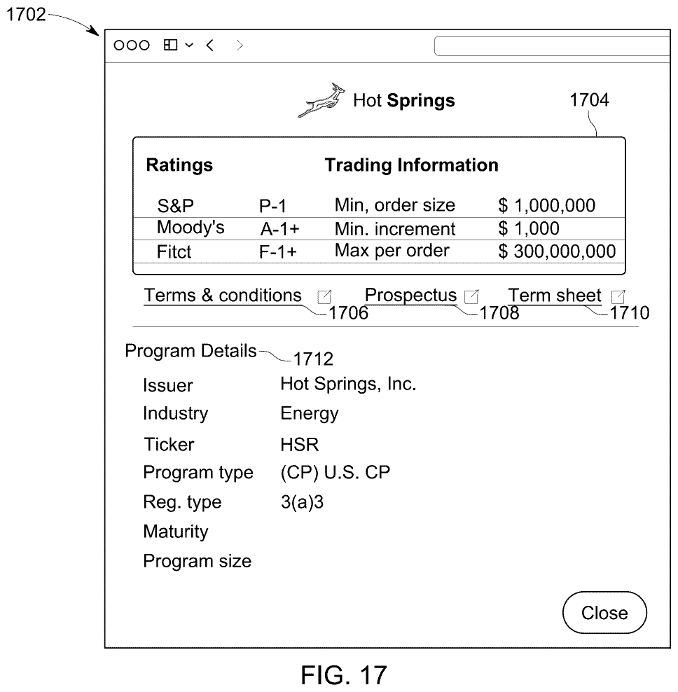

FIG. 17 illustrates an exemplary issuer summary 1702. In various embodiments, the issuer summary 1702 can include trading information 1704 (e.g., ratings from the various ratings agencies, Trading information (e.g., minimum order size, minimum increment, and maximum per order). The issuer summary 1702 can also include links to terms and conditions 1706, prospectus 1708, and term sheet 1710. The issuer summary 1702 can also include program details 1712 (e.g., issuer full name, industry, Ticker, Program type, Regulation type, Maturity, and program size).

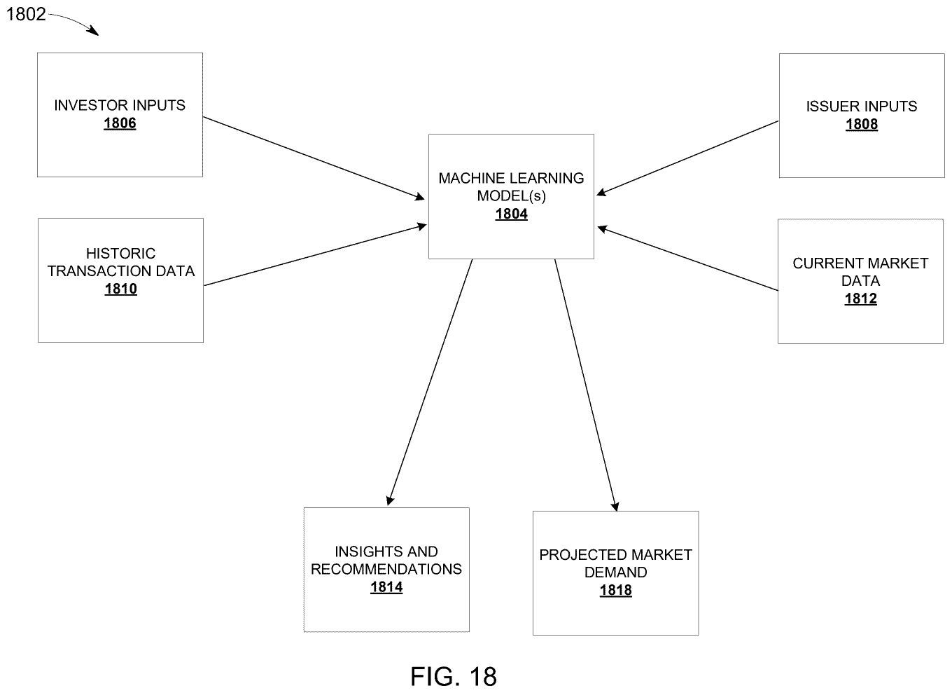

FIG. 18 illustrates an exemplary block diagram 1802 for a machine learning model for a commercial paper transaction. One or more machine learning models 1804 can receive a plurality of inputs to predict one or more results for a commercial paper transaction.

Machine learning (ML) offers a wide range of models that can be applied to financial transactions, each with specific strengths depending on the task.

Linear Regression models can be used for predicting continuous numerical outcomes. In financial transactions, linear regression can help forecast trends like stock prices, currency rates, or other financial metrics.

Logistic Regression models can be ideal for binary classification tasks. Logistic regression is often used in credit risk assessment, fraud detection, or any scenario where the outcome is binary (e.g., default or not).

Decision Trees and Random Forests models can be used for classification and regression tasks. Random forests, which are ensembles of decision trees, tend to perform better by reducing overfitting. In finance, they are used for credit risk scoring, portfolio management, and fraud detection.

Gradient Boosting Machines (GBM) and XGBoost are advanced ensemble models that are built on the concept of boosting. They are particularly effective in scenarios requiring high accuracy and can be used for risk assessment, customer segmentation, or predicting financial trends.

Support Vector Machines (SVM) are useful for classification and regression, especially when data is high-dimensional. They can be applied in fraud detection, credit scoring, and other situations requiring a clear boundary between classes.

Neural Networks and Deep Learning, which include Convolutional Neural Networks (CNNs) and Recurrent Neural Networks (RNNs), are suitable for complex pattern recognition tasks. They are used in algorithmic trading, sentiment analysis, credit scoring, and predicting market trends.

Natural Language Processing (NLP) Models, like those based on transformers (e.g., BERT, GPT), are used for analyzing unstructured text. In finance, they can analyze news articles, press releases, social media, and other text sources to extract sentiment and predict market movements.

Clustering Models (e.g., K-Means, DBSCAN) can group similar data points. In financial transactions, clustering can be used to segment customers, identify patterns in trading data, or detect abnormal activities in transaction flows.

Anomaly Detection Models can detect unusual patterns in data, which is valuable in fraud detection and risk management. Techniques like Isolation Forests or One-Class SVM are commonly used.

Reinforcement Learning (RL) can be used for decision-making problems where the goal is to maximize a reward over time. In finance, RL can be applied to algorithmic trading, portfolio optimization, or even risk management.

Bayesian Models can be useful for incorporating prior knowledge and dealing with uncertainty. In financial transactions, Bayesian models can be used for risk assessment, financial forecasting, and other scenarios where probabilities and uncertainty play a key role.

Each model has specific use cases, advantages, and limitations. The choice of model depends on the problem, the data available, computational resources, and the specific goals of the financial transaction.

Machine learning models can be specifically trained for the commercial paper (CP) transaction market by designing them to reflect the unique features of this specialized and relatively opaque financial domain. The process begins with clearly defining the objective of the model. In the context of commercial paper, these objectives typically fall into a few categories: predicting which firms are likely to issue CP in the near future, estimating investor demand or pricing behavior, forecasting overall market activity, or identifying anomalies in issuance patterns or pricing.

To support these objectives, the model must be trained on a carefully curated and integrated dataset. This data may include transactional data from the Depository Trust & Clearing Corporation (DTCC), which provides detailed records of CP trades, including information on issuers, yields, maturities, and volumes. In addition, the system can incorporate issuer-specific financial data—such as liquidity ratios, short-term debt obligations, and cash flow statements, from SEC filings. Broader macroeconomic indicators like interest rates, Treasury yields, SOFR or LIBOR benchmarks, and inflation data provide context for market conditions. Behavioral data, such as corporate treasury policies, press releases, and earnings call transcripts, can also offer valuable insights into a firm's likely funding behavior.

Once the data is collected, it must be preprocessed and aligned—often by standardizing timestamps and merging different datasets at a common frequency, such as daily or weekly intervals. Textual data can be analyzed using natural language processing techniques to extract sentiment, detect relevant keywords, or identify topics related to liquidity management and CP issuance.

Feature engineering is a critical step in this process. For example, the model might use historical issuance patterns, changes in yield spreads, or indicators of financial stress to create predictive variables. It might also incorporate real-time indicators of market liquidity or investor behavior. Features derived from text, such as the use of terms like “short-term funding” or “cash reserves” in earnings calls, can help flag firms likely to access the CP market.

With the dataset and features in place, the model can be trained using a variety of machine learning techniques. For predicting whether a company will issue CP, classification models such as logistic regression, random forests, or gradient boosting can be used. For estimating the volume or yield of CP issuance, regression models may be more appropriate. Time-series models like LSTMs or Transformer-based architectures are especially useful for modeling sequential trends in issuance activity or investor demand. Unsupervised models, such as clustering algorithms, can also be used to segment issuers or detect unusual market conditions. In more complex implementations, reinforcement learning could simulate dynamic interactions between issuers, investors, and market conditions over time.

Labeling the data for training depends on the goal. For classification, the model might be trained on historical issuer behavior, labeling time periods when a firm issued CP as positive cases. For regression, the model could use issuance amounts or yield spreads as targets. In all cases, model performance should be carefully evaluated using appropriate metrics, such as accuracy, precision, and recall for classification, or root mean squared error and R2 for regression. In time-series contexts, walk-forward validation can help ensure robustness over time.

Given the evolving nature of financial markets, these models should be retrained periodically, such as on a monthly or quarterly basis. It's important to track for model drift and incorporate real-time updates such as changes in economic policy, shifts in interest rates, or market shocks. Where possible, human input from credit analysts or market participants can help fine-tune or validate predictions, especially in cases where transparency is limited.

As a practical example, a firm might build a model that predicts the likelihood of CP issuance by major corporate borrowers based on recent yield curve movements, the firm's short-term debt maturity profile, liquidity position, and the tone of recent management statements. Alternatively, a time-series model might be used to forecast weekly CP market issuance across different maturity buckets, using macroeconomic variables, credit spreads, and historical issuance patterns.

Training machine learning models in this space requires both a deep understanding of market mechanics and careful attention to data quality and feature selection. When well-designed, these models can provide powerful predictive insights into CP issuance trends, investor behavior, and overall market dynamics.

In various embodiments, at least one input can include the investor inputs 1806. The investor inputs 1806 can include type of order (e.g., market or limit order), amount of order, maturity timeline, and rate information.

In various embodiments, at least one input can include the issuer inputs 1808. The investor inputs 1806 can include real time book size, target par amount, rate range, and maturity date.

In various embodiments, at least one input can include historical transaction data 1810. The historical transaction data can include pricing information from previous closed transactions. The historical transaction data can be aggregated with identifying information removed (anonymized).

In various embodiments, at least one input can include current market data 1812. The current market data 1812 can include information from the Depository Trust & Clearing Corporation (DTCC). DTCC is an American post-trade financial services company providing clearing and settlement services to the financial markets. DTCC can perform the exchange of securities on behalf of buyers and sellers and functions as a central securities depository by providing central custody of securities.

The machine learning model 1804 can generate one or more outputs.

Machine learning (ML) models can play a significant role in commercial paper transactions, adding efficiency, accuracy, and predictive capabilities. ML models can evaluate the creditworthiness of issuers of commercial paper. By analyzing financial statements, historical data, and other relevant metrics, ML can predict the likelihood of default, allowing investors to make more informed decisions. ML algorithms can detect anomalies and patterns that suggest fraudulent activity. In commercial paper markets, where transactions occur quickly, these algorithms can provide real-time monitoring to identify and mitigate potential fraud.

Machine learning can help with the accurate pricing of commercial paper. By analyzing market trends, historical data, interest rates, and other financial indicators, ML models can suggest optimal pricing for these instruments.

For investors with diversified portfolios, ML can assist in managing commercial paper investments. These models can suggest asset allocation, predict price trends, and provide insights into optimal buying and selling times.

ML algorithms, particularly those designed for natural language processing (NLP), can analyze news articles, press releases, and social media to gauge market sentiment. This information can inform decisions about the desirability and risk associated with certain commercial paper issues.

Companies issuing commercial paper can use ML to optimize their cash flow and liquidity. By analyzing operational data, ML models can predict cash flow patterns and determine when and how much commercial paper should be issued to meet short-term obligations.

ML-based systems can automate various aspects of commercial paper transactions, such as compliance checks, documentation, and trade execution. This can lead to faster transactions, reduced operational costs, and decreased error rates.

Machine learning can help ensure compliance with financial regulations. ML algorithms can automate the process of monitoring transactions, ensuring they adhere to legal and regulatory requirements.

To implement these applications effectively, organizations must ensure they have high-quality data, robust infrastructure, and skilled personnel to develop, deploy, and maintain ML models. Additionally, privacy and data security should be top priorities to maintain the trust and integrity of the commercial paper market.

In various embodiments, at least one output can include insights and recommendations 1814 for the pricing and distribution for commercial paper transactions. In various embodiments, three recommendation models can be used for all the three personas (e.g., dealers (e.g., banks), issuers (e.g., corporates), and investors (e.g., institutional buyside). The model can use all the direct transactions of dealers, issuers, and investors as training data. The training data can include but is not limited to historical data from partners. Investor information can be more challenging to obtain due to privacy and compliance issues.

From an investor/buyer perspective, the machine learning model can analyze and provide insights on existing investments and plan for upcoming maturities. The model can provide recommendations to investors on which issuer to transact with based on requirements (e.g., rating, price, industry, etc.). Some parameters can include an investor's previous transactions and the return on investment, investor's current limitations on approved list of issuers, sector constraints, and investor client constraints. The machine learning model can simulate and forecast predictions based on scenarios.

From an issuer perspective, the machine learning model can provide insights to an issuer on timing and pricing/rates. The machine learning model can provide simulation based on various factors (e.g., time, amount, rating, maturity, peers in market, etc.) The machine learning model can generate investor relations based at least in part on historic investor data on their issuances (e.g., based on trades that happened on the platform). The machine learning model can leverage the issuer's previous transactions and the return on investments, underlying risk-free rate (SOFR), macroeconomic data announcements (e.g., unemployment, inflation, etc.), and other issuances occurring in the market (e.g., both commercial paper and broadly in fixed income). Additionally, the machine learning model can account for issuer's mandates and requirements for investor distribution (e.g., concentration, maximum percentage limit per issue), seasonality of issuer program (i.e., some only coming to market during specific windows in the year, others more frequently), diversity and inclusion, dealer relationships, insights, and recommendations.

From a dealer perspective, the machine learning model can provide recommendations on investors, timing, and pricing/rates. The machine learning model can assist in building investor and issuer relations based on historic investor data on their issuances. The machine learning model can leverage dealer's previous transactions and the return on investment, dealer's mandates, and requirements for investor distribution (e.g., concentration, maximum percentage limit per issue), diversity and inclusion, dealer relationships, insights, and recommendations.

Other data parameters that can be used to train the model can include: issuer credit rating, current SOFR, Federal and Treasury rates and their yields, approved issuers (e.g., smaller firms can have a strict policy on which commercial papers that they can purchase), secured/unsecured commercial paper (e.g., issuers with lower rating might back their debt with securities for a better rate and lower investor risks), sector and/or industry, relative value of investments, and market anomalies.

In various embodiments, at least one output can include projected market demand 1818 information.

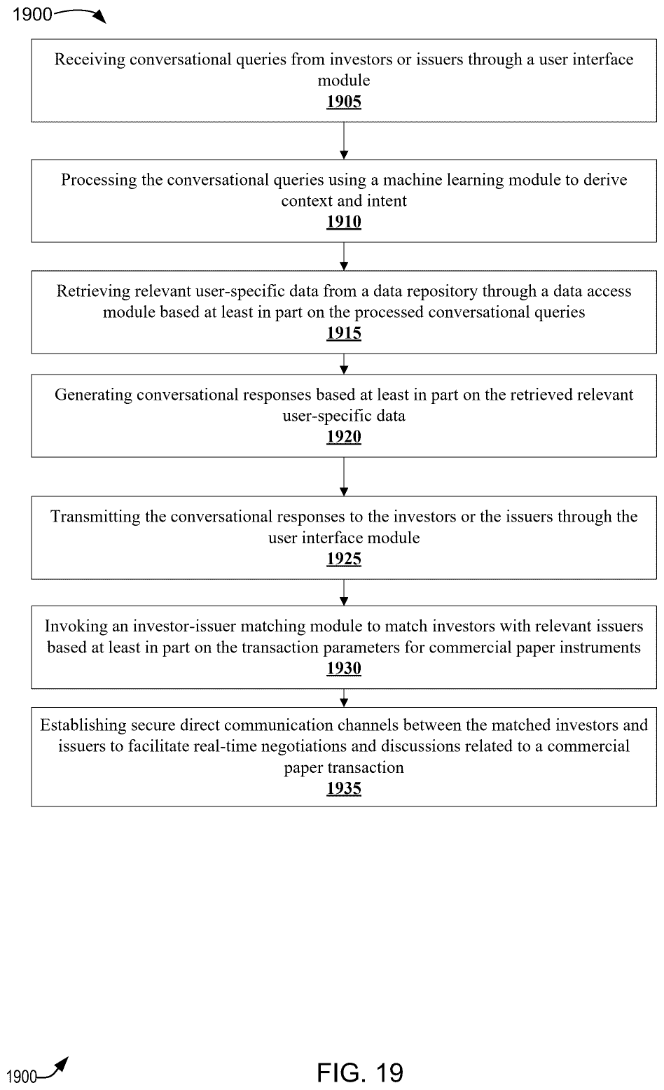

FIG. 19 illustrates an exemplary process for commercial paper transactions. FIG. 19 is a flow chart of a process 1900, according to an example of the present disclosure. According to an example, one or more process blocks of FIG. 19 may be performed by computing device.

At block 1905, process 1900 can include receiving conversational queries from investors or issuers through a user interface module. The conversational queries specify transaction parameters for commercial paper instruments. For example, computing device 2000 may receive conversational queries from investors or issuers through a user interface module. The conversational queries can specify transaction parameters for commercial paper instruments, as described above. In various embodiments, the transaction parameters include one or more of: desired commercial paper instrument size, maturity, pricing strategy, or other relevant terms.

In various embodiments, inputs can be made by a user by a touchscreen, a pointing device (e.g., a mouse), one or more pull down menus, or a chatbot.

At block 1910, process 1900 may include processing the conversational queries using a machine learning module to derive context and intent. For example, computing devices may process conversational queries using a machine learning module to derive context and intent, as described above.

Determining the intent of a user is a critical function for chatbots to deliver meaningful interactions. User intent refers to the underlying purpose or objective that a user has when interacting with a chatbot. Various techniques can be used to determine the intent of a user.

In various embodiments, Natural Language Processing (NLP) can be used as the foundation for understanding human language in chatbots. NLP involves a variety of techniques to process, analyze, and extract meaning from text.

Before intent recognition, chatbots break user input into smaller components (tokens) in a process called Tokenization and Text Processing. This process can remove irrelevant characters, punctuation, or stop words to simplify analysis.

Part-of-Speech (POS) Tagging and Named Entity Recognition can help identify the grammatical role of words (nouns, verbs, adjectives, etc.), while Named Entity Recognition (NER) identifies specific entities like names, locations, or dates. This helps the chatbot understand context.

Keyword Matching can be used by chatbots to identify certain words or phrases that signal specific intents. For example, the presence of words like “weather” or “forecast” might indicate an intent to get weather information.

Context and Dialogue History from previous interactions can be used by chatbots to understand user intent. This is particularly important in multi-turn conversations where the intent might evolve or require reference to earlier statements.

Intent Classification with Machine Learning can be used by chatbots to determine intent.

Supervised Learning can be a Machine Learning process involving training models on labeled datasets where the intent is known. Popular models include logistic regression, decision trees, Random Forests, and neural networks.

More advanced models like Recurrent Neural Networks (RNNs), Long Short-Term Memory (LSTM), or Transformer-based architectures (e.g., BERT, GPT) can capture complex patterns in user input. Support Vector Machines (SVM) and Naive Bayes: Effective for text classification and can be used to categorize intents.

Intent Slot Filling can be used by chatbots to extract specific details (slots) to complete an intent. For example, if the intent is to book a flight, the chatbot might extract slots like departure city, destination, and date.

Confidence Scoring can be used by ML-based chatbots often provide a confidence score indicating how sure they are about an identified intent. If the confidence is low, the chatbot might ask the user for clarification or offer a selection of possible intents.

Chatbots need mechanisms to handle ambiguous input or recover from errors. This might involve asking clarifying questions or providing options to help users express their intent more clearly.

Finally, chatbots can improve their intent recognition capabilities over time through continuous learning. Feedback from users and additional training data help refine and update models, leading to better accuracy and performance.

By combining these approaches, chatbots can determine user intent with a reasonable degree of accuracy, allowing them to respond in a way that meets user expectations and drives meaningful interactions.

At block 1915, process 1900 may include retrieving relevant user-specific data from a data repository through a data access module based at least in part on the processed conversational queries. For example, computing devices may retrieve relevant user-specific data from a data repository through a data access module based at least in part on the processed conversational queries, as described above.

At block 1920, process 1900 may include generating conversational responses based at least in part on the retrieved relevant user-specific data. For example, computing devices may generate conversational responses based at least in part on the retrieved relevant user-specific data, as described above. The chatbot features can be used to generate conversational responses.

Natural Language Processing (NLP) is a subfield of artificial intelligence that focuses on the interaction between computers and humans through natural language. The goal is to enable computers to understand, interpret, and respond to human language in a way that is both meaningful and useful. NLP can incorporate tokenization which can involve breaking down text into smaller units called tokens (e.g., words, phrases) to simply text processing by dividing text into manageable pieces. This can be followed by normalization which is converting text into a consistent format. Some of the steps can include lowercasing, removing punctuation, stemming (reducing words to their root form), and lemmatization (reducing words to their base form). Next, NLP can include part-of-speech tagging which can include identifying the grammatical parts of speech (nouns, verbs, adjectives, etc.) for each token to provide context and meaning to the tokens. Next, named entity recognition (NER) can include Identifying and classifying named entities (people, organizations, dates, etc.) in text to extract useful information and helps in understanding the context. NLP can incorporate parsing techniques to analyze the grammatical structure of sentences. Parsing can include dependency parsing (relationships between words) and constituency parsing (phrase structure). NLP can incorporate sentiment analysis which determines the sentiment or emotional tone of text (positive, negative, neutral) for useful for understanding opinions and emotions in text.

NLP can incorporate word embeddings which can include representing words in continuous vector space where similar words have similar vectors. Some models can include but are not limited to Word2Vec, GloVe, FastText, and contextual embeddings like BERT.

NLP can also include machine translation to translate text from one language to another. Some approaches can include Rule-based, statistical, and neural machine translation.

NLP can include text generation which can include generating new text that is coherent and contextually relevant. Exemplary text generation models can include but are not limited to GPT-3, T5, and other transformer-based models.

NLP can employ various statistical methods such as N-grams and Hidden Markov Models (HMMs). NLP can employ machine learning processes such as but not limited to Support Vector Machines (SVM), Decision Trees, and Naive Bayes.

NLP techniques can perform Deep Learning using Neural Networks such as Recurrent Neural Networks (RNNs), Long Short-Term Memory (LSTM) networks, Convolutional Neural Networks (CNNs). An exemplary NLP Pipeline can include: Data Collection: Gathering text data from various sources, Data Preprocessing: Cleaning and normalizing text data, Feature Extraction: Converting text into numerical features using methods like TF-IDF, word embeddings, Model Training: Using machine learning or deep learning models to learn patterns from the data, Evaluation: Assessing the model's performance using metrics like accuracy, precision, recall, F1 score, Deployment: Integrating the model into applications for real-time use, and Monitoring and Maintenance: Continuously improving and updating the model based on new data and feedback.

At block 1925, process 1900 may include transmitting conversational responses to the investors or the issuers through the user interface module. For example, computing devices may transmit conversational responses to the investors or the issuers through the user interface module, as described above.

At block 1930, process 1900 may include invoking an investor-issuer matching module to match investors with relevant issuers based at least in part on the transaction parameters for commercial paper instruments. This can be accomplished using machine learning using the preferences of both parties in a commercial paper transaction and holdings. For example, computing devices may invoke an investor-issuer matching module to match investors with relevant issuers based at least in part on the transaction parameters for commercial paper instruments, as described above.

An investor-issuer matching module within a commercial paper (CP) transaction system can be designed to efficiently connect companies seeking short-term funding with investors looking to deploy capital into low-risk, short-duration instruments. This module plays a central role in modernizing the CP market by streamlining the process of matching supply and demand, automating parts of the transaction lifecycle, and improving market efficiency.

At its core, the matching module uses a combination of rule-based filters, optimization algorithms, and potentially machine learning techniques to align the specific needs and preferences of issuers and investors. For issuers, the system takes inputs such as the amount of funding required, desired maturity, target interest rate, credit rating, sector, and preferred issuance window. Investors, in turn, input their available capital, risk tolerance (such as minimum acceptable credit rating), preferred maturities and yields, and any issuer restrictions (for example, ESG criteria or industry exclusions).

The matching process begins with an eligibility filter, which removes any potential pairings that do not meet basic criteria. For instance, the system would exclude investors whose risk profile does not align with an issuer's credit rating, or whose target yield is below the issuer's minimum acceptable rate. Once the eligible pairs are identified, the system scores or ranks potential matches based on how closely their criteria align. This scoring process may take into account factors such as the spread between desired and offered yields, the match between requested and available investment duration, and historical success rates of similar pairings.

After scoring, the module may employ optimization techniques to maximize efficiency across the entire system. For example, it might aim to maximize the total volume of CP issued, balance investor exposure across multiple issuers, or prioritize matches that offer the best yield-to-maturity fit. In more advanced systems, machine learning algorithms can refine this process by learning from past outcomes, such as which matches were accepted or rejected, and under what market conditions-and improving match quality over time.

Once matches are identified, the system generates a recommended list of pairings, complete with proposed deal terms. These recommendations can be automatically executed if participants have pre-approved transaction parameters, or they can be submitted to human users-such as treasury teams or portfolio managers, for review and manual approval. After a match is accepted, the system integrates with settlement and documentation workflows to complete the transaction, potentially using smart contracts or digital ledger technology to automate and record the exchange.

In a practical scenario, consider a corporation that needs to raise $50 million through a 30-day commercial paper offering at a target yield of 5.2%. The system identifies a group of investors whose preferences align with this request. Based on available capital and yield targets, the system might match three investors, allocating $20 million to the first at 5.2%, $15 million to the second at 5.15%, and $15 million to the third at 5.25%. Each match is logged, confirmed, and prepared for settlement through the integrated backend system.

The effectiveness of such a module is enhanced by real-time data integration, allowing it to update continuously in response to market changes, shifts in investor appetite, or new issuer entries. Additionally, it can be configured to comply with regulatory requirements and accommodate ethical investment guidelines by embedding filters for ESG ratings, jurisdictional constraints, and compliance checks.

In summary, the investor-issuer matching module serves as the intelligent engine of a digital commercial paper marketplace. By automating and optimizing the process of connecting investors with suitable issuers, it reduces reliance on manual negotiation, accelerates capital allocation, and brings greater transparency and precision to the short-term debt market.

At block 1935, process 1900 may include establishing secure direct communication channels between the matched investors and issuers to facilitate real-time negotiations and discussions related to a commercial paper transaction. For example, computing devices may establish secure direct communication channels between the matched investors and issuers to facilitate real-time negotiations and discussions related to a commercial paper transaction, as described above.

Process 1900 may include additional implementations, such as any single implementation or any combination of implementations described below and/or in connection with one or more other processes described elsewhere herein.

In various embodiments, process 1900 may include generating custom reports using a reporting module based at least in part on the user-specific data and the conversational queries, where the custom reports include visualizations, charts, or graphs.

In various embodiments, process 1900 may include generating predictive insights related to future deal outcomes, issuance performance, or debt raise success based on the historical transaction data and user-specific data using a prediction module.

In various embodiments, the user interface module is configured to facilitate multi-modal conversational interactions, including text, voice, or graphical interactions.

In various embodiments, the investor-issuer matching module is configured to maintain confidentiality and privacy of investor and issuer information during the matching process and direct communication.

In various embodiments, process 1900 may include generating settlement documents for facilitating the execution and settlement of commercial paper transactions resulting from the direct connections between matched investors and issuers using an execution module integrated with existing financial systems or platforms.

Blockchain technology can be used to transform the settlement process for commercial paper (CP) transactions by replacing traditional paper-based documentation with secure, automated, and transparent digital systems. In current CP markets, settlement documents, such as trade confirmations, delivery instructions, and payment records, are often exchanged manually or through semi-automated processes, which can lead to delays, inconsistencies, and increased operational risk. Blockchain offers a more efficient alternative.

At the core of this transformation is the ability to digitize the commercial paper instrument itself. Using blockchain, CP can be represented as a digital asset or token, and its terms, such as issuer identity, maturity date, face value, and interest rate, can be embedded into a smart contract. This smart contract acts as a self-executing agreement, automatically enforcing the terms of the issuance and settlement when predefined conditions are met. For example, once an investor transfers funds, the smart contract can instantly transfer ownership of the digital CP token, eliminating the need for separate settlement documents or manual reconciliation.

One of the key benefits of blockchain is the creation of an immutable audit trail. Every step in the lifecycle of a commercial paper transaction, issuance, trading, settlement, and maturity, can be recorded on a distributed ledger that is visible to all authorized participants. This shared, time-stamped record serves as a single source of truth, eliminating the need for duplicative recordkeeping and manual document exchanges. It also enhances regulatory compliance by providing a transparent and tamper-proof record of all transactions, which can replace traditional settlement confirmations and reports.

Blockchain also enables real-time, multi-party validation. In traditional systems, each party may maintain their own version of a settlement document, which must be reconciled after the fact. On a blockchain, however, all participants, issuers, investors, dealers, and custodians-interact with the same ledger in real time. This removes the need for multiple confirmations and reduces the risk of discrepancies. Smart contracts ensure that settlements occur only when all preconditions, such as KYC/AML verifications or payment instructions, have been fulfilled.

Another major application of blockchain is the tokenization of commercial paper. Each CP note can be issued as a unique digital token on a blockchain network. These tokens can be bought, sold, or transferred directly between parties, much like cryptocurrency. This enables near-instantaneous settlement (T+0), in contrast to the traditional T+1 or T+2 timelines. As a result, settlement risk is dramatically reduced, and the need for detailed post-trade documentation is minimized.

Blockchain can also be integrated with digital payment systems, including central bank digital currencies (CBDCs) or stablecoins. This integration allows for atomic settlement, meaning that the exchange of CP tokens and payment occurs simultaneously on the blockchain. This eliminates the risk of one party delivering while the other fails to pay, a common concern in conventional settlement processes.

The benefits of blockchain become especially clear in cross-border CP transactions. Traditional international settlements are often delayed by differences in time zones, banking hours, and legal frameworks. Blockchain overcomes these obstacles by standardizing documentation, automating compliance checks across jurisdictions, and enabling real-time settlement, regardless of geographic boundaries. Smart contracts can even be programmed to comply with specific legal or regulatory requirements, replacing the need for customized manual agreements.

Real-world experiments have already demonstrated the viability of blockchain for short-term debt instruments. For example, the European Investment Bank has explored blockchain-based issuance and settlement of digital bonds and commercial paper. Despite its promise, there are challenges to adopting blockchain in CP markets. Regulatory frameworks may need to be updated to recognize blockchain-based records and digital CP as legally valid. Privacy concerns may require the use of permissioned or private blockchain networks, particularly since CP transactions often involve sensitive financial information. Additionally, widespread adoption will require standardization of data formats, contract templates, and integration with legacy financial systems.

In summary, blockchain has the potential to significantly streamline the settlement process for commercial paper by digitizing instruments, automating execution through smart contracts, and replacing traditional documentation with secure, transparent, and real-time ledger records. This can reduce costs, minimize settlement risk, and improve overall market efficiency, especially in high-volume or cross-border commercial paper markets.

In various embodiments, the machine learning module is configured to analyze conversational interactions and transaction data to improve the accuracy and relevance of investor-issuer matching over time.

In various embodiments, the data access module is configured to enforce access control and data security policies to ensure secure retrieval and presentation of user-specific data.

In various embodiments, process 1900 further includes receiving feedback from investors or issuers regarding the conversational responses; and incorporating the feedback into the machine learning module to improve future conversational interactions.

It should be noted that while FIG. 19 shows example blocks of process 1900, in some implementations, process 1900 may include additional blocks, fewer blocks, different blocks, or differently arranged blocks than those depicted in FIG. 19. Additionally, or alternatively, two or more of the blocks of process 1900 may be performed in parallel.

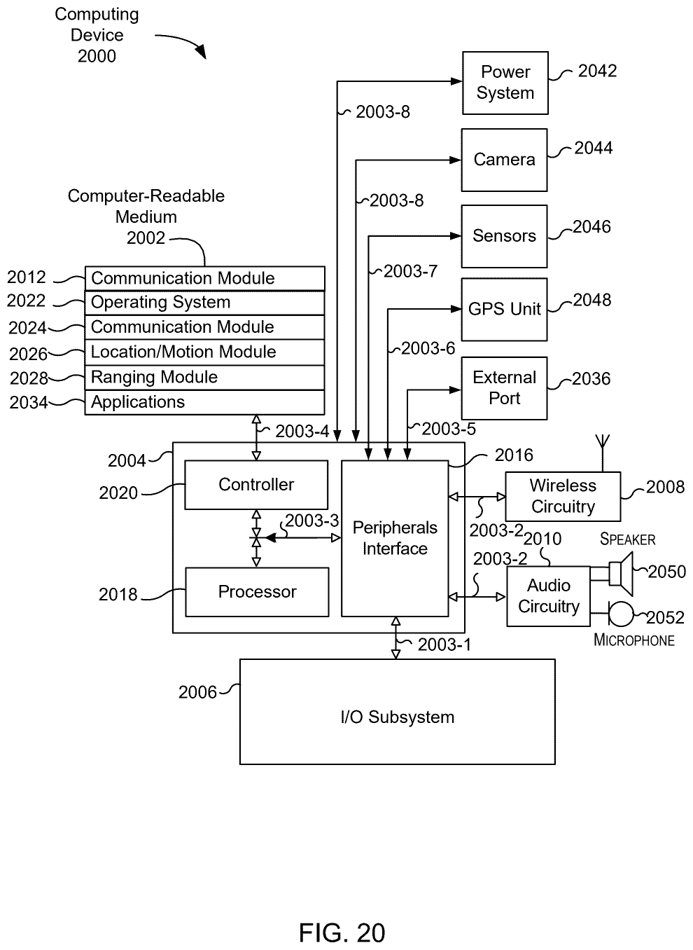

FIG. 20 illustrates a block diagram of an exemplary electronic device 2000. Device 2000 generally includes a processor 2002, a computer-readable medium 2004, a power system 2006, a ranging module 2008, a communication module (e.g., Bluetooth), and I/O subsystem 2012. These components may be coupled by one or more communication buses or signal lines. Device 2000 can be any electronic device, including a handheld computer, a tablet computer, a mobile phone, a laptop computer, a tablet device, a media player, personal digital assistant (PDA), a key fob, a car key, an electronic tag, an access card, a multifunction device, a mobile phone, a portable gaming device, a headset, or the like, including a combination of two or more of these items.

It should be apparent that the architecture shown in FIG. 20 is only one example of an architecture for device 2000, and that device 2000 can have more or fewer components than shown, or a different configuration of components. The various components shown in FIG. 20 can be implemented in hardware, software, or a combination of both hardware and software, including one or more signal processing and/or application specific integrated circuits. Although the electronic device 2000 is depicted as being round in shape it is not so limited.

A communication module 2010 can include wireless circuitry that can be used to send and receive information over a wireless link or network to one or more other devices' conventional circuitry such as an antenna system, a radio frequency (RF) transceiver, one or more amplifiers, a tuner, one or more oscillators, a digital signal processor, a CODEC chipset, memory, etc. Wireless circuitry can use various protocols, e.g., as described herein. In various embodiments, wireless circuitry is capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), Long-term Evolution (LTE)-Advanced, Wi-Fi (such as Institute of Electrical and Electronics Engineers (IEEE) 802.11a, IEEE 802.11b, IEEE 802.11g and/or IEEE 802.11n), Bluetooth, Wi-MAX, voice over Internet Protocol (VOIP), near field communication protocol (NFC), a protocol for email, instant messaging, and/or a short message service (SMS), or any other suitable communication protocol, including communication protocols not yet developed as of the filing date of this document.

One or more processors in 2002 communicate with computer-readable medium 2004. Computer-readable medium 2004 can be any device or medium that can store code and/or data for use by one or more processors 2002. Computer-readable medium 2004 can include a memory hierarchy, including cache, main memory, and secondary memory. The memory hierarchy can be implemented using any combination of RAM (e.g., Standard Random Access Memory (SRAM), Dynamic Random Access Memory (DRAM), Double Data Random Access Memory (DDRAM), Read only Memory (ROM), FLASH, magnetic and/or optical storage devices, such as disk drives, magnetic tape, CDs (compact disks) and DVDs (digital video discs).

Processor(s) 2002 can include hardware and/or software elements that perform one or more processing functions, such as mathematical operations, logical operations, data manipulation operations, data transfer operations, controlling the reception of user input, controlling output of information to users, or the like. Processor(s) 2002 can be embodied as one or more hardware processors, microprocessors, microcontrollers; field programmable gate arrays (FPGAs), application-specified integrated circuits (ASICs), or the like.

Device 2000 may include storage and processing circuitry such as control circuitry 2016. Control circuitry 2016 may include storage such as hard disk drive storage, nonvolatile memory (e.g., flash memory or other electrically-programmable-read-only memory configured to form a solid-state drive), volatile memory (e.g., static, or dynamic random-access-memory), etc. Processing circuitry in control circuitry 2016 may be used to control the operation of device 2000. This processing circuitry may be based on one or more microprocessors, microcontrollers, digital signal processors, baseband processor integrated circuits, application specific integrated circuits, etc.

Control circuitry 2016 may be used to run software on device 2000, such as internet browsing applications, voice-over-internet-protocol (VOIP) telephone call applications, email applications, media playback applications, operating system functions, etc. To support interactions with external equipment, control circuitry 2016 may be used in implementing communications protocols. Communications protocols that may be implemented using control circuitry 2016 include internet protocols, wireless local area network protocols (e.g., IEEE 802.11 protocols-sometimes referred to as Wi-Fi®), protocols for other short-range wireless communications links such as the Bluetooth® protocol, cellular telephone protocols, multiple-input and multiple-output (MIMO) protocols, antenna diversity protocols, satellite navigation system protocols, millimeter wave communications protocols, IEEE 802.15.4 ultra-wideband communications protocols, etc.

Device 2000 may include I/O subsystem 2012. I/O subsystem 2012 may include input-output devices. Input-output devices may be used to allow data to be supplied to device 2000 and to allow data to be provided from device 2000 to external devices. Input-output devices may include user interface devices, data port devices, and other input-output components. For example, input-output devices may include one or more displays (e.g., touch screens or displays without touch sensor capabilities), one or more image sensors (e.g., digital image sensors), motion sensors, and speakers. Input-output device may also include buttons, joysticks, scrolling wheels, touch pads, key pads, keyboards, microphones, haptic elements such as vibrators and actuators, status indicators, light sources, audio jacks and other audio port components, digital data port devices, light sensors, capacitance sensors, proximity sensors (e.g., a capacitive proximity sensor and/or an infrared proximity sensor), magnetic sensors, and other sensors and input-output components.

Device 2000 also includes a power system 2006 for powering the various hardware components. Power system 2006 can include a power management system, one or more power sources (e.g., battery, alternating current (AC)), a recharging system, a power failure detection circuit, a power converter or inverter, a power status indicator (e.g., a light emitting diode (LED)) and any other components typically associated with the generation, management and distribution of power in mobile devices.

In some embodiments, device 2000 includes an image sensor (e.g., a camera). In some embodiments, device 2000 includes sensors. Sensors can include accelerometers, compass, gyrometer, pressure sensors, audio sensors, light sensors, barometers, and the like. Sensors can be used to sense location aspects, such as auditory or light signatures of a location.

In some embodiments, device 2000 can include a GPS receiver, sometimes referred to as a GPS unit. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information.

One or more processors 2002 run various software components stored in computer-readable medium 2004 to perform various functions for device 2000. In some embodiments, the software components include an operating system, a communication module 2010 (or set of instructions), a location module (or set of instructions), a ranging module 2008 that is used as part of ranging operation described herein, and other application programs (or set of instructions).

Operating system can be any suitable operating system, including iOS, Mac OS, Darwin, Quatros Real-Time Operating System (RTXC), LINUX, UNIX, OS X, WINDOWS, or an embedded operating system such as VxWorks. The operating system can include various procedures, sets of instructions, software components, and/or drivers for controlling and managing general system tasks (e.g., memory management, storage device control, power management, etc.) and facilitates communication between various hardware and software components.

Communication module 2010 facilitates communication with other devices over one or more external ports or via wireless circuitry and includes various software components for handling data received from wireless circuitry and/or external port. External ports (e.g., universal serial bus (USB), Fire Wire, Lightning connector, 60-pin connector, etc.) are adapted for coupling directly to other devices or indirectly over a network (e.g., the Internet, wireless LAN, etc.).

Location/motion module can assist in determining the current position (e.g., coordinates or other geographic location identifiers) and motion of device 2000. Modern positioning systems include satellite-based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module receives data from GPS unit 2048 and analyzes the signals to determine the current position of the mobile device. In some embodiments, location/motion module can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry and is passed to location/motion module. In some embodiments, the location module receives one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for device 2000 based on the position coordinates of the corresponding transmitters. Regardless of the specific location technology used, location/motion module receives information from which a location fix can be derived, interprets that information, and returns location information, such as geographic coordinates, latitude/longitude, or other location fix data.

Ranging module 2008 can send/receive ranging messages to/from an antenna, e.g., connected to wireless circuitry. The messages can be used for various purposes, e.g., to identify a sending antenna of a device, determine timestamps of messages to determine a distance of mobile device 2000 from another device. Ranging module 2008 can exist on various processors of the device, e.g., an always-on processor (AOP), a UWB chip, and/or an application processor. For example, parts of ranging module 2008 can determine a distance on an AOP, and another part of the ranging module can interact with a sharing module, e.g., to display a position of the other device on a screen in order for a user to select the other device to share a data item. Ranging module 2008 can also interact with a reminder module that can provide an alert based on a distance from another mobile device.

Dielectric-filled openings such as plastic-filled openings may be formed in metal portions of housing such as in metal sidewall structures (e.g., to serve as antenna windows and/or to serve as gaps that separate portions of antennas from each other).

Antennas may be mounted in housing. If desired, some of the antennas (e.g., antenna arrays that may implement beam steering, etc.) may be mounted under dielectric portions of device 2000 (e.g., portions of the display cover layer, portions of a plastic antenna window in a metal housing sidewall portion of housing, etc.). With one illustrative configuration, some or all of rear face of device 2000 may be formed from a dielectric. For example, the rear wall of housing may be formed from glass plastic, ceramic, or another dielectric. In this type of arrangement, antennas may be mounted within the interior of device 2000 in a location that allows the antennas to transmit and receive antenna signals through the rear wall of device 2000 (and, if desired, through optional dielectric sidewall portions in housing). Antennas may also be formed from metal sidewall structures in housing and may be located in peripheral portions of device 2000.

To avoid disrupting communications when an external object such as a human hand or other body part of a user blocks one or more antennas, antennas may be mounted at multiple locations in housing. Sensor data such as proximity sensor data, real-time antenna impedance measurements, signal quality measurements such as received signal strength information, and other data may be used in determining when one or more antennas is being adversely affected due to the orientation of housing, blockage by a user's hand or other external object, or other environmental factors. Device 2000 can then switch one or more replacement antennas into use in place of the antennas that are being adversely affected.

Antennas may be mounted at the corners of housing, along the peripheral edges of housing, on the rear of housing, under the display cover layer that is used in covering and protecting display on the front of device 2000 (e.g., a glass cover layer, a sapphire cover layer, a plastic cover layer, other dielectric cover layer structures, etc.), under a dielectric window on a rear face of housing or the edge of housing, under a dielectric rear wall of housing, or elsewhere in device 2000. As an example, antennas may be mounted at one or both ends of device 2000 (e.g., along the upper and lower edges of housing, at the corners of housing, etc.).

Antennas in device 2000 may include cellular telephone antennas, wireless local area network antennas (e.g., Wi-Fi® antennas at 2.4 GHz and 5 GHz and other suitable wireless local area network antennas), satellite navigation system signals, and near-field communications antennas. The antennas may also include antennas that support IEEE 802.15.4 ultra-wideband communications protocols and/or antennas for handling millimeter wave communications. For example, the antennas may include two or more ultra-wideband frequency antennas and/or millimeter wave phased antenna arrays. Millimeter wave communications, which are sometimes referred to as extremely high frequency (EHF) communications, involve signals at 60 GHz or other frequencies between about 10 GHz and 400 GHz.

Wireless circuitry in device 2000 may support communications using the IEEE 802.15.4 ultra-wideband protocol. In an IEEE 802.15.4 system, a pair of devices may exchange wireless time stamped messages. Time stamps in the messages may be analyzed to determine the time of flight of the messages and thereby determine the distance (range) between the devices.

Image sensors may include one or more visible digital image sensors (visible-light cameras) and/or one or more infrared digital image sensors (infrared-light cameras). Image sensors may, if desired, be used to measure distances. For example, an infrared time-of-flight image sensor may be used to measure the time that it takes for an infrared light pulse to reflect back from objects in the vicinity of device 2000, which may in turn be used to determine the distance to those objects. Visible imaging systems such as a front and/or rear-facing camera in device 2000 may also be used to determine the position of objects in the environment. For example, control circuitry may use image sensors to perform simultaneous localization and mapping (SLAM). SLAM refers to the process of using images to determine the position of objections in the environment while also constructing a representation of the imaged environment. Visual SLAM techniques include detecting and tracking certain features in images such as edges, textures, room corners, window corners, door corners, faces, sidewalk edges, street edges, building edges, tree trunks, and other prominent features. Control circuitry 2016 may rely entirely upon image sensors to perform simultaneous localization and mapping, or control circuitry 2016 may synthesize image data with range data from one or more distance sensors (e.g., light-based proximity sensors). If desired, control circuitry 2016 may use display to display a visual representation of the mapped environment.

Input-output devices may include motion sensor circuitry. Motion sensor circuitry may include one or more accelerometers (e.g., accelerometers that measure acceleration along one, two, or three axes), gyroscopes, barometers, magnetic sensors (e.g., compasses), image sensors (e.g., image sensor) and other sensor structures. Sensors may, for example, include one or more microelectromechanical systems (MEMS) sensors (e.g., accelerometers, gyroscopes, microphones, force sensors, pressure sensors, capacitive sensors, or any other suitable type of sensor formed using microelectromechanical systems technology).

Control circuitry 2016 may be used to store and process motion sensor data. If desired, motion sensors, processing circuitry, and storage that form motion sensor circuitry may form part of a system-on-chip integrated circuit (as an example).

Input-output devices may include movement generation circuitry. Movement generation circuitry may receive control signals from control circuitry 2016. Movement generation circuitry may include electromechanical actuator circuitry that, when driven, moves device 2000 in one or more directions. For example, movement generation circuitry may laterally move device 2000 and/or may rotate device 2000 around one or more axes of rotation. Movement generation circuitry may, for example, include one or more actuators formed at one or more locations of device 2000. When driven by a motion control signal, actuators may move (e.g., vibrate, pulse, tilt, push, pull, rotate, etc.) to cause device 2000 to move or rotate in one or more directions. The movement may be slight (e.g., not noticeable, or barely noticeable to a user of device 2000), or the movement may be substantial. Actuators may be based on one or more vibrators, motors, solenoids, piezoelectric actuators, speaker coils, or any other desired device capable of mechanically (physically) moving device 2000.

Some or all of movement generation circuitry such as actuators may be used to perform operations that are unrelated to rotation of device 2000. For example, actuators may include vibrators that are actuated to issue a haptic alert or notification to a user of device 2000. Such alerts may include, for example, a received text message alert identifying that device 2000 has received a text message, a received telephone call alert, a received email alert, an alarm notification alert, a calendar notification alert, or any other desired notification. By actuating actuator, device 2000 may inform the user of any desired device condition.

Motion sensor circuitry may sense motion of device 2000 that is generated by movement generation circuitry. If desired, motion sensor circuitry may provide feedback signals associated with the sensed motion of device 2000 to movement generation circuitry. Movement generation circuitry may use feedback signals to control actuation of the movement generation circuitry.

Control circuitry 2016 may use motion sensor circuitry and/or movement generation circuitry to determine the angle of arrival of wireless signals received by device 2000 from another electronic device. For example, control circuitry 2016 may use movement generation circuitry to move device 2000 from one position to another. Motion sensor circuitry may be used to track the movement of device 2000 as it is moved between the different positions. At each position, control circuitry 2016 may receive wireless signals from another electronic device. Control circuitry 2016 may process the received wireless signals together with the motion data from motion sensor circuitry to more accurately determine the position of the other electronic device. The use of motion generation circuitry is merely illustrative, however. If desired, motion sensor circuitry may track movement of device 2000 that is not caused by motion generation circuitry. This may include a user's natural, unprompted movement of device 2000 and/or the user's movement of device 2000 after the user is prompted (by display, audio circuitry, a haptic output device in device 2000, or any other suitable output device) to move device 2000 in a particular fashion.

Other sensors that may be included in input-output devices include ambient light sensors for gathering information on ambient light levels, proximity sensor components (e.g., light-based proximity sensors, capacitive proximity sensors, and/or proximity sensors based on other structures), depth sensors (e.g., structured light depth sensors that emit beams of light in a grid, a random dot array, or other pattern, and that have image sensors that generate depth maps based on the resulting spots of light produced on target objects), sensors that gather three-dimensional depth information using a pair of stereoscopic image sensors, LIDAR (light detection and ranging) sensors, radar sensors, and other suitable sensors.

Input-output circuitry may include wireless communications circuitry for communicating wirelessly with external equipment. Wireless communications circuitry may include radio frequency (RF) transceiver circuitry formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications).

Communications module 2010 may include radio-frequency transceiver circuitry for handling various radio-frequency communications bands. For example, communication module 2010 may include transceiver circuitry.

Transceiver circuitry may be wireless local area network transceiver circuitry. Transceiver circuitry may handle 2.4 GHz and 5 GHz bands for Wi-Fi® (IEEE 802.11) communications and may handle the 2.4 GHz Bluetooth® communications band.

Circuitry may use cellular telephone transceiver circuitry for handling wireless communications in frequency ranges such as a communications band from 700 to 960 MHz, a band from 1710 to 2170 MHz, a band from 2300 to 2700 MHz, other bands between 700 and 2700 MHz, higher bands such as LTE bands 42 and 43 (3.4-3.6 GHz), or other cellular telephone communications bands. Circuitry may handle voice data and non-voice data.

Millimeter wave transceiver circuitry (sometimes referred to as extremely high frequency transceiver circuitry) may support communications at extremely high frequencies (e.g., millimeter wave frequencies such as extremely high frequencies of 10 GHz to 400 GHz or other millimeter wave frequencies). For example, circuitry may support IEEE 802.11ad communications at 60 GHz. Circuitry may be formed from one or more integrated circuits (e.g., multiple integrated circuits mounted on a common printed circuit in a system-in-package device, one or more integrated circuits mounted on different substrates, etc.).

Ultra-wideband transceiver circuitry may support communications using the IEEE 802.15.4 protocol and/or other wireless communications protocols. Ultra-wideband wireless signals may be characterized by bandwidths greater than 500 MHz or bandwidths exceeding 20% of the center frequency of radiation. The presence of lower frequencies in the baseband may allow ultra-wideband signals to penetrate through objects such as walls. Transceiver circuitry may operate in a 2.4 GHz frequency band, a 6.5 GHz frequency band, an 8 GHz frequency band, and/or at other suitable frequencies.

Wireless communications circuitry may include satellite navigation system circuitry such as Global Positioning System (GPS) receiver circuitry for receiving GPS signals at 1575 MHz or for handling other satellite positioning data (e.g., GLONASS signals at 1609 MHz). Satellite navigation system signals for receiver are received from a constellation of satellites orbiting the earth.

In satellite navigation system links, cellular telephone links, and other long-range links, wireless signals are typically used to convey data over thousands of feet or miles. In Wi-Fi® and Bluetooth® links at 2.4 and 5 GHz and other short-range wireless links, wireless signals are typically used to convey data over tens or hundreds of feet. Extremely high frequency (EHF) wireless transceiver circuitry may convey signals over these short distances that travel between transmitter and receiver over a line-of-sight path. To enhance signal reception for millimeter wave communications, phased antenna arrays and beam steering techniques may be used (e.g., schemes in which antenna signal phase and/or magnitude for each antenna in an array is adjusted to perform beam steering). Antenna diversity schemes may also be used to ensure that the antennas that have become blocked or that are otherwise degraded due to the operating environment of device 2000 can be switched out of use and higher-performing antennas used in their place.

Wireless communications circuitry can include circuitry for other short-range and long-range wireless links if desired. For example, wireless communications circuitry 36 may include circuitry for receiving television and radio signals, paging system transceivers, near field communications (NFC) circuitry, etc.

The one or more applications on device 2000 can include any applications installed on the device 2000, including without limitation, a browser, address book, contact list, email, instant messaging, social net weighted, word processing, keyboard emulation, widgets, JAVA-enabled applications, encryption, digital rights management, voice recognition, voice replication, a music player (which plays back recorded music stored in one or more files, such as MP3 or advanced audio codec (AAC) files), etc.

There may be other modules or sets of instructions (not shown), such as a graphics module, a time module, etc. For example, the graphics module can include various conventional software components for rendering, animating, and displaying graphical objects (including without limitation text, web pages, icons, digital images, animations, and the like) on a display surface. In another example, a timer module can be a software timer. The timer module can also be implemented in hardware. The time module can maintain various timers for any number of events.

I/O subsystem 2012 can be coupled to a display system (not shown), which can be a touch-sensitive display. The display displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 2012 can include a display and user input devices such as a keyboard, mouse, and/or trackpad. In some embodiments, I/O subsystem 2012 can include a touch-sensitive display. A touch-sensitive display can also accept input from the user based at least part on haptic and/or tactile contact. In some embodiments, a touch-sensitive display forms a touch-sensitive surface that accepts user input. The touch-sensitive display/surface (along with any associated modules and/or sets of instructions in computer-readable medium) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, I/O subsystem 2012 can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 2000 can include a touchpad (not shown) for activating or deactivating particular functions. In some embodiments, the touchpad is a touch-sensitive area of the device 2000 that, unlike the touch screen, does not display visual output. The touchpad can be a touch-sensitive surface that is separate from the touch-sensitive display, or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Although the present disclosure has been described with respect to specific embodiments, it will be appreciated that the disclosure is intended to cover all modifications and equivalents within the scope of the following claims.

All patents, patent applications, publications, and descriptions mentioned herein are incorporated by reference in their entirety for all purposes. None is admitted to being prior art.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting the implementations. Thus, the operation and behavior of the systems and/or methods are described herein without reference to specific software code-it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such.

What is claimed is:

1. A computer implemented method for facilitating commercial paper transactions, the method comprising:
receiving conversational queries from investors or issuers through a user interface module, wherein the conversational queries specify transaction parameters for commercial paper instruments;
processing the conversational queries using a machine learning module to derive context and intent;
retrieving relevant user-specific data from a data repository through a data access module based at least in part on the processed conversational queries;
generating conversational responses based at least in part on the retrieved relevant user-specific data;
transmitting the conversational responses to the investors or the issuers through the user interface module;
invoking an investor-issuer matching module to match investors with relevant issuers based at least in part on the transaction parameters for commercial paper instruments; and
establishing secure direct communication channels between the matched investors and issuers to facilitate real-time negotiations and discussions related to a commercial paper transaction.

2. The computer implemented method for facilitating commercial paper transactions of claim 1, wherein the transaction parameters include one or more of: desired commercial paper instrument size, maturity, pricing strategy, or other relevant terms.

3. The computer implemented method for facilitating commercial paper transactions of claim 1, further comprising generating custom reports using a reporting module based at least in part on the relevant user-specific data and the conversational queries, wherein the custom reports include visualizations, charts, or graphs.

4. The computer implemented method for facilitating commercial paper transactions of claim 1, further comprising generating predictive insights related to future deal outcomes, issuance performance, or debt raise success based on historical transaction data and user-specific data using a prediction module.

5. The computer implemented method for facilitating commercial paper transactions of claim 1, wherein the user interface module is configured to facilitate multi-modal conversational interactions, including text, voice, or graphical interactions.

6. The computer implemented method for facilitating commercial paper transactions of claim 1, further comprising generating settlement documents for facilitating an execution and settlement of commercial paper transactions resulting from direct connections between matched investors and issuers using an execution module integrated with existing financial systems or platforms.

7. The computer implemented method for facilitating commercial paper transactions of claim 1, wherein the machine learning module is configured to analyze conversational interactions and transaction data to improve an accuracy and a relevance of investor-issuer matching over time.

8. A non-transitory computer-readable medium storing a set of instructions for facilitating commercial paper transactions, the set of instructions comprising one or more instructions that, when executed by one or more processors of a device, cause the device to:
receive conversational queries from investors or issuers through a user interface module, wherein the conversational queries specify transaction parameters for commercial paper instruments;
process the conversational queries using a machine learning module to derive context and intent;
retrieve relevant user-specific data from a data repository through a data access module based at least in part on the processed conversational queries;
generate conversational responses based at least in part on the retrieved relevant user-specific data;
transmit the conversational responses to the investors or the issuers through the user interface module;
invoke an investor-issuer matching module to match investors with relevant issuers based at least in part on the transaction parameters for commercial paper instruments; and
establish secure direct communication channels between the matched investors and issuers to facilitate real-time negotiations and discussions related to a commercial paper transaction.

9. The non-transitory computer-readable medium of claim 8, wherein the transaction parameters include one or more of a desired commercial paper instrument size, a maturity, a pricing strategy, or other relevant terms.

10. The non-transitory computer-readable medium of claim 8, wherein the one or more instructions further cause the device to generate custom reports using a reporting module based at least in part on the relevant user-specific data and the conversational queries, wherein the custom reports include visualizations, charts, or graphs.

11. The non-transitory computer-readable medium of claim 8, wherein the one or more instructions further cause the device to generate predictive insights related to future deal outcomes, issuance performance, or debt raise success based on historical transaction data and user-specific data using a prediction module.

12. The non-transitory computer-readable medium of claim 8, wherein the user interface module is configured to facilitate multi-modal conversational interactions comprising at least one of text, voice, or graphical interactions.

13. The non-transitory computer-readable medium of claim 8, wherein the one or more instructions further cause the device to generate settlement documents for facilitating an execution and settlement of commercial paper transactions resulting from direct connections between matched investors and issuers using an execution module integrated with existing financial systems or platforms.

14. The non-transitory computer-readable medium of claim 8, wherein the machine learning module is configured to analyze conversational interactions and transaction data to improve an accuracy and a relevance of investor-issuer matching over time.

15. A system for facilitating commercial paper transactions comprising one or more processors configured to:
receive conversational queries from investors or issuers through a user interface module, wherein the conversational queries specify transaction parameters for commercial paper instruments;
process the conversational queries using a machine learning module to derive context and intent;
retrieve relevant user-specific data from a data repository through a data access module based at least in part on the processed conversational queries;
generate conversational responses based at least in part on the retrieved relevant user-specific data;
transmit the conversational responses to the investors or the issuers through the user interface module;
invoke an investor-issuer matching module to match investors with relevant issuers based at least in part on the transaction parameters for commercial paper instruments; and
establish secure direct communication channels between the matched investors and issuers to facilitate real-time negotiations and discussions related to a commercial paper transaction.

16. The system of claim 15, wherein the transaction parameters include one or more of a desired commercial paper instrument size, a maturity, a pricing strategy, or other relevant terms.

17. The system of claim 15, wherein the one or more processors are further configured to generate custom reports using a reporting module based at least in part on the relevant user-specific data and the conversational queries, wherein the custom reports include visualizations, charts, or graphs.

18. The system of claim 15, wherein the one or more processors are further configured to generate predictive insights related to future deal outcomes, issuance performance, or debt raise success based on historical transaction data and user-specific data using a prediction module.

19. The system of claim 15, wherein the user interface module is configured to facilitate multi-modal conversational interactions, including at least one of text, voice, or graphical interactions.

20. The system of claim 15, wherein the one or more processors are further configured to generate settlement documents for facilitating an execution and settlement of commercial paper transactions resulting from direct connections between matched investors and issuers using an execution module integrated with existing financial systems or platforms.
